(19) United States
(12) Patent Application Publication
(10) Pub. No.: US 2003/0135609 A1
(43) Pub. Date: Jul. 17, 2003

(54) Method, system, and program for determining a modification of a system resource configuration

(75) Inventors: Mark A. Carlson, Boulder, CO (US); Rowan E. da Silva, Nashau, NH (US)

Correspondence Address: David W. Victor, KONRAD RAYNES VICTOR & MANN LLP, 315 S. Beverly Drive; Suite 210, Beverly Hills, CA, 90212, US

(73) Assignee: Sun Microsystems, Inc.

(21) Appl. No.: 10/051,991

(22) Filed: Jan. 16, 2002

(51) Int. Cl. G06F 15/16

(52) U.S. Cl. 709/224; 709/226; 709/221

(57) ABSTRACT

Provided are a method, system, and program for managing multiple resources in a system at a service level, including at least one host, network, and a storage space comprised of at least one storage system that each host is capable of accessing over the network. A plurality of service level parameters are measured and monitored indicating a state of the resources in the system. A determination is made of values for the service level parameters and whether the service level parameter values satisfy predetermined service level thresholds. Indication is made as to whether the service level parameter values satisfy the predetermined service thresholds. A determination is made of a modification to one or more resource deployments or configurations if the value for the service level parameter for the resource does not satisfy the predetermined service level thresholds.

### BACKGROUND OF THE INVENTION

1. Field of the Invention

The present invention relates to a method, system, and program for determining a modification of a system resource configuration.

2. Description of the Related Art

A storage area network (SAN) comprises a network linking one or more servers to one or more storage systems. Each storage system could comprise any combination of a Redundant Array of Independent Disks (RAID) array, tape backup, tape library, CD-ROM library, or JBOD (Just a Bunch of Disks) components. Storage area networks (SAN) typically use the Fibre Channel protocol, which uses optical fibers to connect devices and provide high bandwidth communication between the devices. In Fibre Channel terms the one or more switches interconnecting the devices is called a “fabric”. However, SANs may also be implemented in alternative protocols, such as InfiniBand**, IPStorage over Gigabit Ethernet, etc. **JINI, JIRO, JAVA, SUN, and SUN MICROSYSTEMS are trademarks of Sun Microsystems, Inc. InfiniBand is a service mark of the InfiniBand Trade Association; MICROSOFT and NET are trademarks of Microsoft Corporation.

In the current art, to add or modify the allocation of storage or other resources in a SAN, an administrator must separately utilize different software programs to configure the SAN resources to reflect the modification to the storage allocation. For instance to allow a host to alter the allocation of storage space in the SAN, the administrator would have to perform one or more of the following:

use a storage device configuration tool to resize a logical volume, such as a logical unit number (LUN), or change the logical volume configuration at the storage device, e.g., the RAID or JBOD, to provide more or less storage space to the host.

use a switch configuration tool to alter the assignment of paths in the switch to the host, i.e., rezoning, to provide access to the newly reconfigured logical volume (LUN).

perform LUN masking, which involves altering the assignment of HBA interface ports to the reconfigured LUNs.

use a host volume manager configuration tool to alter the allocation of physical storage to logical volumes used by the host. For instance if the administrator adds storage, then the logical volume must be updated to reflect the added storage.

use a backup program manager to reflect the change in storage allocation so that the backup program will backup more or less data for the host.

use a snapshot copy configuration manager to update the host logical volumes that are subject to a snapshot copy, where a backup copy is made by copying the pointers in the logical volume.

Not only does the administrator have to invoke one or more of the above tools to implement the requested storage allocation change throughout the SAN, but the administrator may also have to perform these configuration operations repeatedly if the configuration of multiple distributed devices is involved. For instance, to add several gigabytes of storage to a host logical volume, the administrator may allocate storage space on different storage subsystems in the SAN, such as different RAID boxes. In such case, the administrator would have to separately invoke the configuration tool for each separate device involved in the new allocation. Further, when allocating more storage space to a host logical volume, the administrator may have to allocate additional storage paths through separate switches that lead to the one or more storage subsystems including the new allocated space. The complexity of the configuration operations the administrator must perform further increases as the number of managed components in a SAN increase. Moreover, the larger the SAN, the greater the likelihood of hosts requesting storage space reallocations to reflect new storage allocation needs.

Additionally, many systems administrators are generalists and may not have the level of expertise to use a myriad of configuration tools to appropriately configure numerous different vendor resources. Still further, even if an administrator develops the skill and knowledge to optimally configure networks of components from different vendors, there is a concern for knowledge retention in the event the skilled administrator separates from the organization. Yet further, if administrators are not utilizing their configuration knowledge and skills, then their skill level at performing the configurations may decline.

All these factors, including the increasing complexity of storage networks, decreases the likelihood that the administrator may provide an optimal configuration.

The above described difficulties in configuring resources in a Fibre Channel SAN

environment are also experienced in other storage environments including multiple storage devices, hosts, and switches, such as InfiniBand**, IPStorage over Gigabit Ethernet, etc. **JINI, JIRO, JAVA, SUN, and SUN MICROSYSTEMS are trademarks of Sun Microsystems, Inc. InfiniBand is a service mark of the InfiniBand Trade Association; MICROSOFT and NET are trademarks of Microsoft Corporation.

For all the above reasons, there is a need in the art for an improved technique for managing and configuring the allocation of resources in a large network, such as a SAN.

### SUMMARY OF THE PREFERRED EMBODIMENTS

Provided are a method, system, and program for managing multiple resources in a system at a service level, including at least one host, a network, and a storage space comprised of at least one storage system that each host is capable of accessing over the network. A plurality of service level parameters are measured and monitored indicating a state of the resources in the system. A determination is made of values for the service level parameters and whether the service level parameter values satisfy predetermined service level thresholds. Indication is made as to whether the service level parameter values satisfy the predetermined service thresholds. A determination is made of a modification to one or more resource deployments or configurations if the value for the service level parameter for the resource does not satisfy the predetermined service level thresholds.

In further implementations, the service level parameters that are monitored are members of a set of service level parameters that may include: a downtime during which the at least one host is unable to access the storage space; a number of times the at least one host was unable to access the storage space; a throughput in terms of bytes per second transferred between the at least one host and the storage; and an I/O transaction rate.

In further implementations, a time period is associated with one of the monitored service parameters. In such implementations, a determination is made of a time during which the value of the service level parameter associated with the time period does not satisfy the predetermined service level threshold. A message is generated indicating failure of the value of the service level parameter to satisfy the predetermined service level threshold after the time during which the value of the service level parameter has not satisfied the predetermined service level threshold exceeds the time period.

Yet further, determining the modification of the at least one resource deployment further comprises analyzing the resource deployment to determine at least one resource that contributes to the failure of the service level parameter values to satisfy the threshold. A determination is made as to whether any additional instances of the determined at least one resource that contributes to the failure of the service level parameter is available. At least one additional instance of the determined at least one resource is allocated to the system.

In still further implementations, a plurality of applications at different service levels are accessing the resources in the system. Requests from applications operating at a higher service level receive higher priority than requests from applications operating at a lower service level. In such case, determining the modification of the at least one resource deployment further comprises increasing the priority associated with the service whose service level parameter values fail to satisfy the predetermined service level thresholds.

The described implementations provide techniques to monitor parameters of system performance that may be specified within a service agreement. The service agreement may specify predetermined service level thresholds that are to be maintained as part of the service offering. With the described implementations, if the monitored service level parameter values fail to satisfy the predetermined thresholds, such as thresholds specified in a service agreement, then the relevant parties are notified and various corrective actions are recommended to bring the system operation back to within the predetermined performance thresholds.

### BRIEF DESCRIPTION OF THE DRAWINGS

Referring now to the drawings in which like reference numbers represent corresponding parts throughout:

FIG. 1 illustrates a network computing environment for one implementation of the invention;

FIG. 2 illustrates a component architecture in accordance with certain implementations of the invention;

FIG. 3 illustrates a component architecture for a storage network in accordance with certain implementations of the invention;

FIG. 4 illustrates logic to invoke a configuration operation in accordance with certain implementations of the invention;

FIG. 5 illustrates logic to configure network components in accordance with certain implementations of the invention;

FIG. 6 illustrates further components within the administrator user interface to define and execute configuration policies in accordance with certain implementations of the invention;

FIGS. 7-8 illustrate GUI panels through which a user invokes a configuration policy to configure and allocate resources to provide storage in accordance with certain implementations of the invention;

FIGS. 9-10 illustrate logic implemented in the configuration policy tool to enable a user to invoke and use a defined configuration policy to allocate and configure (provision) system resources in accordance with certain implementations of the invention;

FIG. 11 illustrates information maintained with the element configuration service attributes in accordance with certain implementations of the invention;

FIG. 12 illustrates a data structure providing service attribute information for each element configuration policy in accordance with certain implementations of the invention;

FIG. 13 illustrates a GUI panel through which an administrator may define a configuration policy to configure resources in accordance with certain implementations of the invention;

FIG. 14 illustrates logic to dynamically define a configuration policy in accordance with certain implementations of the invention;

FIG. 15 illustrates a further implementation of the administrator user interface in accordance with implementations of the invention;

FIGS. 16a and 16b illustrate logic to gather service metrics in accordance with implementations of the invention;

FIG. 17 illustrates logic to monitor whether metrics are satisfying agreed upon threshold objectives in accordance with implementations of the invention; and

FIG. 18 illustrates logic to recommend a modification to the system configuration in accordance with implementations of the invention.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

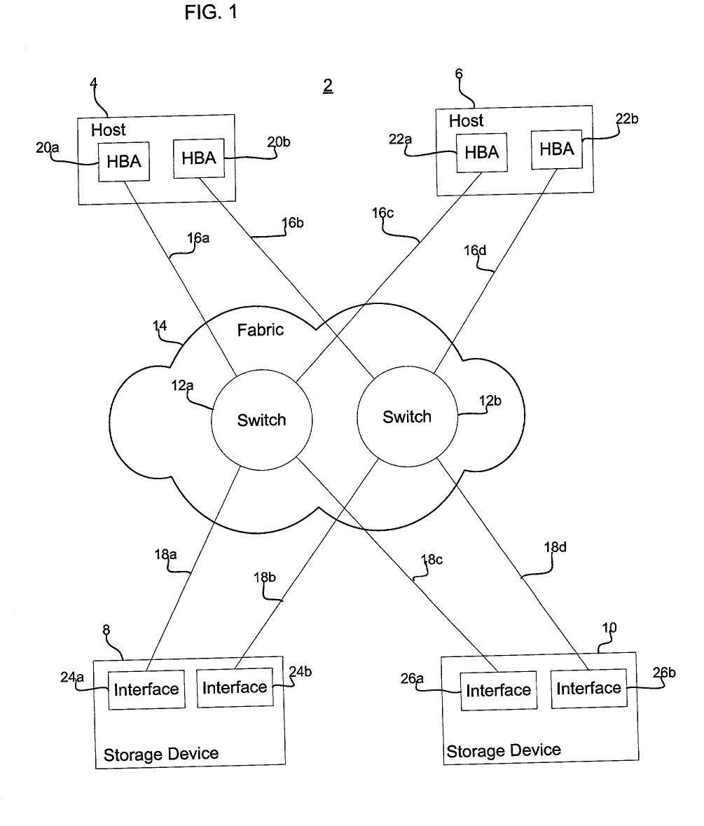

FIG. 1 illustrates an implementation of a Fibre Channel based storage area network (SAN) which may be configured using the implementations described herein. Host computers 4 and 6 may comprise any computer system that is capable of submitting an Input/Output (I/O) request, such as a workstation, desktop computer, server, mainframe, laptop computer, handheld computer, telephony device, etc. The host computers 4 and 6 would submit I/O requests to storage devices 8 and 10. The storage devices 8 and 10 may comprise any storage device known in the art, such as a JBOD (just a bunch of disks), a RAID array, tape library, storage subsystem, etc. Switches 12a, b interconnect the attached devices 4, 6, 8, and 10. The fabric 14 comprises the switches 12a, b that enable the interconnection of the devices. In the described implementations, the links 16a, b, c, d and 18a, b, c, d connecting the devices comprise Fibre Channel fabrics, Internet Protocol (IP) switches, Infiniband fabrics, or other hardware that implements protocols such as Fibre Channel Arbitrated Loop (FCAL), IP, Infiniband, etc. In alternative implementations, the different components of the system may comprise any network communication technology known in the art. Each device 4, 6, 8, and 10 includes multiple Fibre Channel interfaces 20a, 20b, 22a, 22b, 24a, 24b, 26a, and 26b, where each interface, also referred to as a device or host bus adaptor (HBA), can have one or more ports. Moreover, actual SAN implementation may include additional storage devices, hosts, host bus adaptors, switches, etc., than those illustrated in FIG. 1. Moreover, storage functions such as volume management, point-in-time copy, remote copy and backup, can be implemented in hosts, switches and storage devices in various implementations of a SAN.

A path, as that term is used herein, refers to all the components providing a connection from a host to a storage device. For instance, a path may comprise host adaptor 20a, fiber 16a, switch 12a, fiber 18a, and device interface 24a, and the storage devices or disks being accessed.

Certain described implementations provide a configuration technique that allows administrators to select a specific service configuration policy providing the path availability, RAID level, etc., to use to allocate, e.g., modify, remove or add, storage resources used by a host 4, 6 in the SAN 2. After the service configuration policy is specified, the component architecture implementation described herein automatically configures all the SAN components to implement the requested allocation at the specified configuration quality without any further administrator involvement, thereby streamlining the SAN storage resource configuration and allocation process. The requested allocation of the configuration is referred to as a service configuration policy that implements a particular configuration requested by calling the element configuration policies to handle the resource configuration. The policy provides a definition of configurations and how these elements in SAN are to be configured. In certain described implementations, the configuration architecture utilizes the Sun Microsystems, Inc. (“SUN”) Jiro distributed computing architecture.** **JINI, JIRO, JAVA, SUN, and SUN MICROSYSTEMS are trademarks of Sun Microsystems, Inc. InfiniBand is a service mark of the InfiniBand Trade Association; MICROSOFT and NET are trademarks of Microsoft Corporation.

Jiro provides a set of program methods and interfaces to allow network users to locate, access, and share network resources, referred to as services. The services may represent hardware devices, software devices, application programs, storage resources, communication channels, etc. Services are registered with a central lookup service server, which provides a repository of service proxies. A network participant may review the available services at the lookup service and access service proxy objects that enable the user to access the resource through the service provider. A “proxy object” is an object that represents another object in another memory or program memory address space, such as a resource at a remote server, to enable access to that resource or object at the remote location. Network users may “lease” a service, and access the proxy object implementing the service for a renewable period of time.

A service provider discovers lookup services and then registers service proxy objects and service attributes with the discovered lookup service. In Jiro, the service proxy object is written in the Java** programming language, and includes methods and interfaces to allow users to invoke and execute the service object located through the lookup service. A client accesses a service proxy object by querying the lookup service. The service proxy object provides Java interfaces to enable the client to communicate with the service provider and access the service available through the network. In this way, the client uses the proxy object to communicate with the service provider to access the service. **JINI, JIRO, JAVA, SUN, and SUN MICROSYSTEMS are trademarks of Sun Microsystems, Inc. InfiniBand is a service mark of the InfiniBand Trade Association; MICROSOFT and NET are trademarks of Microsoft Corporation.

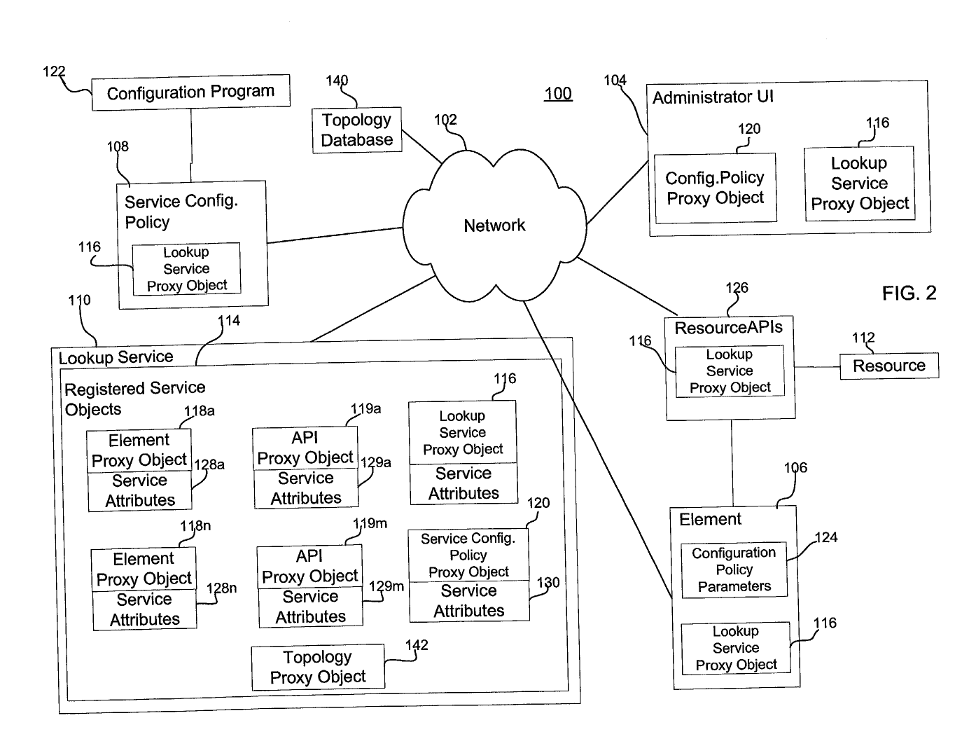

FIG. 2 illustrates a configuration architecture 100 using Jiro components to configure resources available over a network 102, such as hosts, switches, storage devices, etc. The network 102 may comprise the fiber links provided through the fabric 14, or may comprise a separate network using Ethernet or other network technology. The network 102 allows for communication among an administrator user interface (UI) 104, one or more element configuration policies 106 (only one is shown, although multiple element configuration policies 106 may be present), one or more service configuration policies (only one is shown) 108, and a lookup service 110.

The network 102 may comprise the Internet, an Intranet, a LAN, etc., or any other network system known in the art, including wireless and non-wireless networks. The administrator UI 104 comprises a system that submits requests for access to network resources. For instance, the administrator UI 104 may request a new allocation of storage resources to hosts 4, 6 (FIG. 1) in the SAN 2. The administrator UI 104 may be implemented as a program within the host 4, 6 involved in the new storage allocation or a within system remote to the host. The administrator UI 104 provides access to the configuration resources described herein to alter the configuration of storage resources to hosts. The element configuration policies 106 provide a management interface to provide configuration and control over a resource 112. In SAN implementations, the resource 112 may comprise any resource in the system that is configured during the process of allocating resources to a host. For instance, the configurable resources 112 may include host bus adaptors 20a, b, 22a, b, a host, switch or storage device volume manager which provides an assignment of logical volumes in the host, switch or storage device to physical storage space in storage devices 8,10, a backup program in the host 4, 6, a snapshot program in the host 4, 6 providing snapshot services (i.e., copying of pointers to logical volumes), switches 12a, b, storage devices 8, 10, etc. Multiple elements may be defined to provide different configuration qualities for a single resource. Each of the above components in the SAN would comprise a separate resource 112 in the system, where one or more element configuration policies 106 are provided for management and configuration of the resource. The service configuration policy 108 implements a particular service configuration requested by the host 104 by calling the element configuration policies 106 to configure the resources 112.

In the architecture 100, the element configuration policy 106, service configuration policy 108, and resource APIs 126 function as Jini** service providers that make services available to any network participant, including to each other and to the administrator UI 104. The lookup service 110 provides a Jini lookup service in a manner known in the art. **JINI, JIRO, JAVA, SUN, and SUN MICROSYSTEMS are trademarks of Sun Microsystems, Inc. InfiniBand is a service mark of the InfiniBand Trade Association; MICROSOFT and NET are trademarks of Microsoft Corporation.

The lookup service 110 maintains registered service objects 114, including a lookup service proxy object 116, that enables network users, such as the administrator UI 104, element configuration policies 106, service configuration policies 108, and resource APIs 126 to access the lookup service 110 and the proxy objects 116, 118a . . . n, 119a . . . m, and 120 therein. In certain implementations, the lookup service does not contain its own proxy object, but is accessed via a Java Remote Method Invocation (RMI) stub which is available to each Jini service. For instance, each element configuration policy 106 registers an element proxy object 118a . . . n, each resource API 126 registers an API proxy object 119a . . . m, and each service configuration policy 108 registers a service configuration policy proxy object 120 to provide access to the respective resources. The service configuration policy 108 includes code to call element configuration policies 106 to perform the user requested configuration operations to reallocate storage resources to a specified host and logical volume. Thus, the proxy object 118a . . . n may comprise an RMI stub. Further, the lookup service proxy object is not within the lookup service including the other proxy objects.

With respect to the element configuration policies 106, the resources 112 comprise the underlying service resource being managed by the element 106, e.g., the storage devices 8, 10, host bus adaptors 16a, b, c, d, switches 12a, b, host, switch or device volume manager, backup program, snapshot program, etc. The resource application program interfaces (APIs) 126 provide access to the configuration functions of the resource to perform the resource specific configuration operations. Thus, there is one resource API set 126 for each managed resource 112. The APIs 126 are accessible through the API proxy objects 119a . . . m. Because there may be multiple element configuration policies to provide different configurations of a resource 112, the number of registered element configuration policy proxy objects n may exceed the number of registered API proxy objects m, because the multiple element configuration policies 106 that provide different configurations of the same resource 112 would use the same set of APIs 126.

The element configuration policy 106 includes configuration policy parameters 124 that provide the settings and parameters to use when calling the APIs 126 to control the configuration of the resource 112. If there are multiple element configuration policies 106 for a single resource 112, then each of those element configuration policies 106 may provide a different set of configuration policy parameters 124 to configure the resource 112. For instance, if the resource 112 is a RAID storage device, then the configuration policy parameters 124 for one element may provide a RAID level abstract configuration, or some other defined RAID configuration, such as Online Analytical Processing (OLAP) RAID definitions and configurations which may define a RAID level, number of disks, etc. Another element configuration policy may provide a different RAID configuration level. Additionally, if the resource 112 is a switch, then the configuration policy parameters 124 for one element configuration policy 106 may configure redundant paths through the switch to the storage space to avoid a single point of failure, whereas another element configuration policy for the switch may configure only a single path. Thus, the element configuration policies 106 utilize the configuration policy parameters 124 and the resource API 126 to control the configuration of the resource 112, e.g., storage device 8, 10, switches 12a, b, volume manager, backup program, host bus adaptors (HBAs) 20a, b, 22a, b, etc.

Each service configuration policy 108 would call one of the element configuration policies 106 for each resource 112 to perform the administrator/user requested reconfiguration. There may be multiple service configuration policies for different predefined configuration qualities. For instance, there may be a higher quality service configuration policy, such as “gold”, for critical data that would call one element configuration policy 106 for each resource 112 to reconfigure, where the called element configuration policy 106 configures the resource 112 to provide for extra protection, such as a high RAID level, redundant paths through the switch to the storage space to avoid a single point of failure, redundant use of host bus adaptors to further eliminate a single point of failure at the host, etc. A “bronze” or lower quality service configuration policy may not require such redundancy and protection to provide storage space for less critical data. The “bronze” quality service configuration policy 108 would call the element configuration policies 106 that implement such a lower quality configuration policy with respect to the resources 112. Each called element 106 in turn calls the APIs 126 for the resource to reconfigure. Note that different service configuration policies 108 may call the same or different element configuration policies 106 to configure a particular resource.

Associated with each proxy object 118a . . . n, 119a . . . m, and 120 are service attributes or resource capabilities 128a . . . n, 129a . . . n, and 130 that provide descriptive attributes of the proxy objects 118a . . . n, 119a . . . n, and 120. For instance, the administrator UT 104 may use the lookup service proxy object 116 to query the service attributes 130 of the service configuration policy 108 to determine the quality of service provided by the service configuration policy, e.g., the availability, transaction rate, and throughput RAID level, etc. The service attributes 128a . . . n for the element configuration policies 106 may describe the type of configuration performed by the specific element.

FIG. 2 further illustrates a topology database 140 which provides information on the topology of all the resources in the system, i.e., the connections between the host bus adaptors, switches and storage devices. The topology database 140 may be created during system initialization and updated whenever changes are made to the system configuration in a manner known in the art. For instance, the Fibre Channel and SCSI protocols provide protocols for discovering all of the components or nodes in the system and their connections to other components. Alternatively, out-of-band discovery techniques could utilize Simple Network Management Protocol (SNMP) commands to discover all the devices and their topology. The result of the discovery process is the topology database 140 that includes entries identifying the resources in each path in the system. Any particular resource may be available in multiple paths. For instance, a switch may be in multiple entries as the switch may provide multiple paths between different host bus adaptors and storage devices. The topology database 140 can be used to determine whether particular devices, e.g., host bus adaptors, switches and storage devices, can be used, i.e., are actually interconnected. In addition, the topology database 140 keeps track of which resources 112 are available (free) for allocation to a service configuration 108 and which resources 112 have already been allocated (and their topological relationship to each other). The unallocated resources 112 are grouped (pooled) according to their type and resource capabilities and this information is also kept in the topology database 140. The lookup service 114 maintains a topology proxy object 142 that provides methods for accessing the topology database 140 to determine how components in the system are connected.

When the service configuration policy proxy object 120 is created, the topology database 140 may be queried to determine those resources that can be used by the service configuration policy 108, i.e., those resources that when combined can satisfy the configuration policy parameters 124 of the element configuration policies 106 defined for the service configuration policy 108. The service configuration policy proxy object service attributes 130 may be updated to indicate the query results of those resources in the system that can be used with the configuration. The service attributes 130 may further provide topology information indicating how the resources, e.g., host bus adaptors, switches, and storage devices, are connected or form paths. In this way, the configuration policy proxy object service attributes 130 defines all paths of resources that satisfy the configuration policy parameters 124 of the element configuration policies 106 included in the service configuration policy.

In the architecture of FIG. 2, the service providers 108 (configuration policy service), 106 (element), and resource APIs 126 function as clients when downloading the lookup service proxy object 116 from the lookup service 110 and when invoking lookup service proxy object 116 methods and interfaces to register their respective service proxy objects 1118a . . . n, 119a . . . m, and 120 with the lookup service 110. The client administrative user interface (UI) 104 and service providers 106 and 108 would execute methods and interfaces in the service proxy objects 118a . . . n, 119a . . . m, and 120 to communicate with the service provider 106, 108, and 126 to access the associated service. The registered service proxy objects 118a . . . n, 119a . . . m, and 120 represent the services available through the lookup service 110. The administrator UI 104 uses the lookup service proxy object 116 to retrieve the proxy objects from the lookup service 1110. Further details on how clients may discover and download the lookup service and service objects and register service objects are described in the Sun Microsystem, Inc. publications: “Jini Architecture Specification” (Copyright 2000, Sun Microsystems, Inc.) and “Jini Technology Core Platform Specification” (Copyright 2000, Sun Microsystems, Inc.), both of which publications are incorporated herein by reference in their entirety.

The resources 112, element configuration policies 106, service configuration policy 108, and resource APIs 126 may be implemented in any computational device known in the art and each include a Java Virtual Machine (JVM) and a Jiro package (not shown). The Jiro package includes all the Java methods and interfaces needed to implement the Jiro network environment in a manner known in the art. The JVM loads methods and interfaces of the Jiro package as well as the methods and interfaces of downloaded service objects, as bytecodes capable of executing the configuration policy service 108, administrator UI 104, the element configuration policies 106, and resource APIs 126. Each component 104, 106, 108, and 110 further accesses a network protocol stack (not shown) to enable communication over the network. The network protocol stack provides a network access for the components 104, 106, 108, 110, and 126, such as the Transmission Control Protocol/Internet Protocol (TCP/IP), support for unicast and multicast broadcasting, and a mechanism to facilitate the downloading of Java files. The network protocol stack may also include the communication infrastructure to allow objects, including proxy objects, on the systems to communicate via any method known in the art, such as the Common Object Request Broker Architecture (CORBA), Remote Method Invocation (RMI), TCP/IP, etc.

As discussed, the configuration architecture may include multiple elements for the different configurable resources in the storage system. Following are the resources that may be configured through the proxy objects in the SAN:

Storage Devices: There may be a separate element configuration policy service for each configurable storage device 8, 10. In such case, the resource 112 would comprise the configurable storage space of the storage devices 8, 10 and the element configuration policy 106 would comprise the configuration software for managing and configuring the storage devices 8, 10 according to the configuration policy parameters 124. The element configuration policy 106 would call the resource APIs 126 to access the functions of the storage configuration software.

Switch: There may be a separate element configuration policy service for each configurable switch 12a, b. In such case, the resource 112 would comprise the switch configuration software in the switch and the element configuration policy 106 would comprise the switch element configuration policy software for managing and configuring paths within the switch 12a, b according to the configuration policy parameters 124. The element configuration policy 106 would call the resource APIs 126 to access the functions of the switch configuration software.

Host Bus Adaptors: There may be a separate element configuration policy service to manage the allocation of the host bus adaptors 20a, b, 22a, b on each host 4, 6. In such case, the resource 112 would comprise all the host bus adaptors (HBAs) on a given host and the element configuration policies 106 would comprise the element configuration policy software for assigning the host bus adaptors (HBAs) to a path according to the configuration policy parameters 124. The element configuration policy 106 would call the resource APIs 126 to access the functions of the host adaptor configuration software on each host 4, 6.

Volume Manager: There may be a separate element configuration policy service for the volume manager on each host 4, 6, on each switch 12a, 12b and on each storage device 8. 10. In such case, the resource 112 would comprise the mapping of logical to physical storage and the element configuration policy 106 would comprise the software for configuring the mapping of the logical volumes to physical storage space according to the configuration policy parameters 124. The element configuration policy 106 would call the resource APIs 126 to access the functions of the volume manager configuration software.

Backup Program: There may be a separate element service 106 for the backup program configuration at each host 4, 6, each switch 12a, 12b, and each storage device 8, 10. In such case, the resource 112 would comprise the configurable backup program and the element configuration policy 106 would comprise software for managing and configuring backup operations according to the configuration policy parameters 124. The element configuration policy 106 would call the resource APIs 126 to configure the functions of the backup management software.

Snapshot: There may be a separate element service 106 for the snapshot configuration for each host 4, 6. In such case, the resource 112 would comprise the snapshot operation on the host and the element configuration policy 106 would comprise the software to select logical volumes to copy as part of a snapshot operation according to the configuration policy parameters 124. The element configuration policy 106 would call the resource APIs 126 to access the functions of the snapshot configuration software.

Element configuration policy services may also be provided for other network based, storage device based, and host based storage function software other than those described herein.

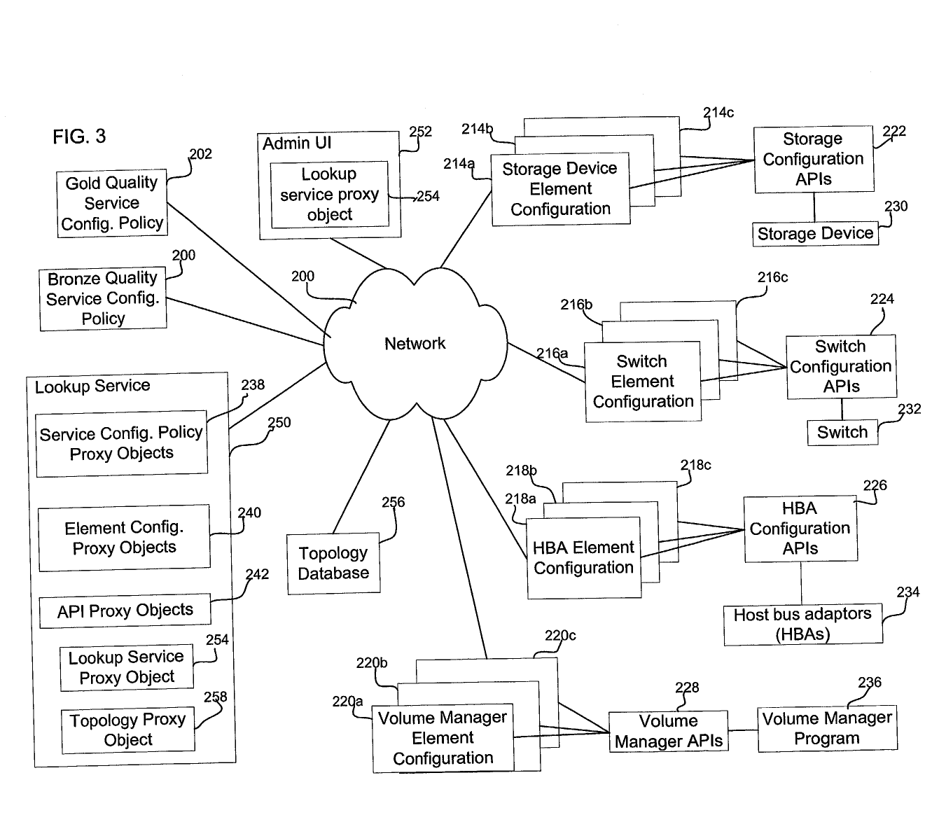

FIG. 3 illustrates an additional arrangement of the element configuration policy, service configuration policies, and APIs for the SAN components that may be available over a network 200, including a gold 202 and bronze 204 quality service configuration polices, each providing a different quality of service configuration for the system components. The service configuration policies 202 and 204 call one element configuration policy for each resource that needs to be configured. The component architecture includes one or more storage device element configuration policies 214a, b, c, switch element configuration policies 216a, b, c, host bus adaptor (HBA) element configuration policies 218a, b, c, and volume manager element configuration policies 220a, b, c. The element configuration policies 214a, b, c, 216a, b, c, 218a, b, c, and 220a, b, c call the resource APIs 222, 224, 226, and 228, respectively, that enable access and control to the commands and functions used to configure the storage device 230, switch 232, host bus adaptors (HBA) 234, and volume manager 236, respectively. In certain implementations, the resource API proxy objects are associated with service attributes that describe the availability and performance of associated resources, i.e., available storage space, available paths, available host bus adaptor, etc. In the described implementations, there is a separate resource API object for each instance of the device, such that if there are two storage devices in the system, then there would be two storage configuration APIs, each providing the APIs to one of the storage devices. Further, the proxy object for each resource API would be associated with service attributes describing the availability and performance at the resource to which the resource API provides access.

Each of the service configuration policies 202 and 204, element configuration policies 214a, b, c, 216a, b, c, 218a,b, c, and 220a, b, c, and resource APIs 222, 224, 226, and 228 would register their respective proxy objects with the lookup service 250. For instance, the service configuration policy proxy objects 238 include the proxy objects for the gold 202 and bronze 200 quality service configuration polices; the element configuration proxy objects 240 include the proxy objects for each element configuration policy 214a, b, c, 216a, b, c, 218a, b, c, 220a, b, c configuring a resource 230, 232, 234, and 236; and the API proxy objects 242 include the proxy objects for each set of device APIs 222, 224, 226, and 228. As discussed each service configuration policy 200, 202 would call one element configuration policy for each of the resources 230, 232, 234, and 236 that need to be configured to implement the user requested configuration quality. Each device element configuration policy 214a, b, c, 216a, b, c, 218a, b, c, and 220a, b, c maintains configuration policy parameters (not shown) that provide a particular quality of configuration of the managed resource. Moreover, additional device element configuration policies would be provided for each additional device in the system. For instance, if there were two storage devices in the SAN system, such as a RAID box and a tape drive, there would be separate element configuration policies to manage each different storage device and separate proxy objects and accompanying APIs to allow access to each of the element configuration policies for the storage devices. Further, there would be one or more host bus adaptor (HBA) element configuration policies for each host system to allow configuration and management of all the host bus adaptors (HBAs) in a particular host 4, 6 (FIG. 1). Each proxy object would be associated with service attributes providing information on the resource being managed, such as the amount of available disk space, available paths in the switch, available host bus adaptors at the host, configuration quality, etc.

An administrator user interface (UI) 252 operates as a Jiro client and provides a user interface to enable access to the lookup service proxy object 254 from the lookup service 250 and enable access to the lookup service proxy object 254 to access the proxy objects for the service configuration policies 202 and 204. The administrator 252 is a process running on any system, including the device components shown in FIG. 3, that provides a user interface to access, run, and modify configuration policies. The service configuration policies 202, 204 call the element configuration policies 214a, b, c, 216a, b, c, 218a, b, c, and 220a, b, c to configure each resource 230, 232, 234, 236 to implement the allocation of the additional requested storage space to the host. The service configuration polices 202, 204 would provide a graphical user interface (GUI) to enable the administrator to enter resources to configure. Before a user at the administrator UI 252 could utilize the above described component architecture of FIG. 3 to configure components of a SAN system, e.g., the SAN 2 in FIG. 1, the service configuration policies 202, 204, element configuration policies 214a, b, c, 216a, b, c, 218a, b, c, and 220a, b, c would have to discover and join the lookup service 250 to register their proxy objects. Further, each of the service configuration policies 202 and 204 must download the element configuration policy proxy objects 240 for the elements configuration policies 214a, b, c, 216a, b, c, 218a, b, c, and 220a, b, c. The element configuration policies 214a, b, c, 216a, b, c, 218a, b, c, and 220a, b, c, in turn, must download one of the API proxy objects 242 for resource APIs 222, 224, 226, and 228, respectively, to perform the desired configuration according to the configuration policy parameters maintained in the element configuration policy and the host storage allocation request.

FIG. 3 further shows a topology database 256 and topology proxy object 258 that allows access to the topology information on the database. Each record includes a reference to the resources in a path.

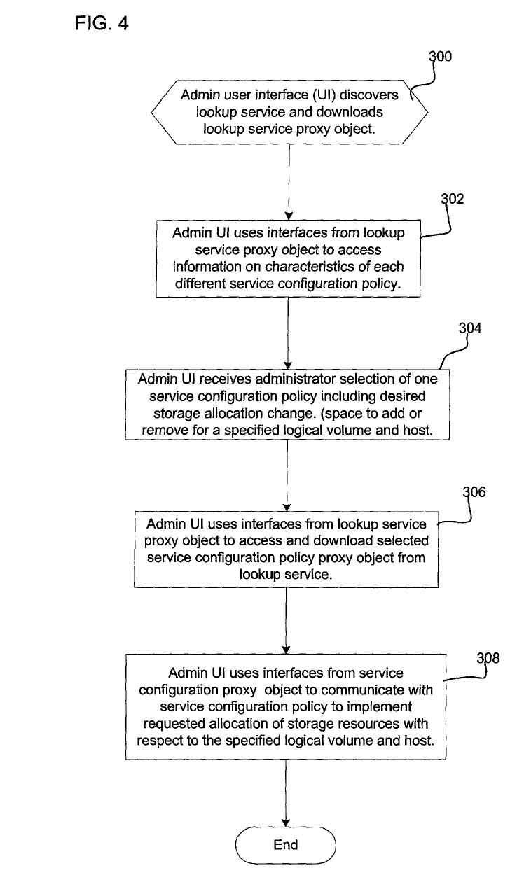

FIG. 4 illustrates logic implemented within the administrator UI 252 to begin the configuration process utilizing the configuration architecture described with respect to FIGS. 2 and 3. Control begins at block 300 with the administrator UI 252 (“admin UI”) discovering the lookup service 250 and uses the lookup service proxy object 254, which as discussed may be an RMI stub. The administrator UI 252 then uses (at block 302) the interfaces of the lookup service proxy object 254 to access information on the service attributes providing information on each service configuration policy 202 and 204, such as the quality of availability, performance, and path redundancy. A user may then select one of the service configuration policies 202 and 204 appropriate to the availability, performance, and redundancy needs of the application that will use the new allocation of storage. For instance, a critical database application would require high availability, OLTP performance, and redundancy, whereas an application involving non-critical data requires less availability and redundancy. The administrator UI 252 then receives user selection (at bock 304) of one of the service configuration policies 202, 204 and a host and logical volume and other device components, such as switch 232 and storage device 230 to configure for the new storage allocation. The administrator UI 252 may execute within the host to which the new storage space will be allocated or be remote to the host.

The administrator UI 252 then uses (at block 306) interfaces from the lookup service proxy object 254 to access and download the selected service configuration policy proxy object. The administrator UI 252 uses (at block 308) interfaces from the downloaded service configuration policy proxy object to communicate with the selected service configuration policy 202 or 204 to implement the requested storage allocation for the specified logical volume and host.

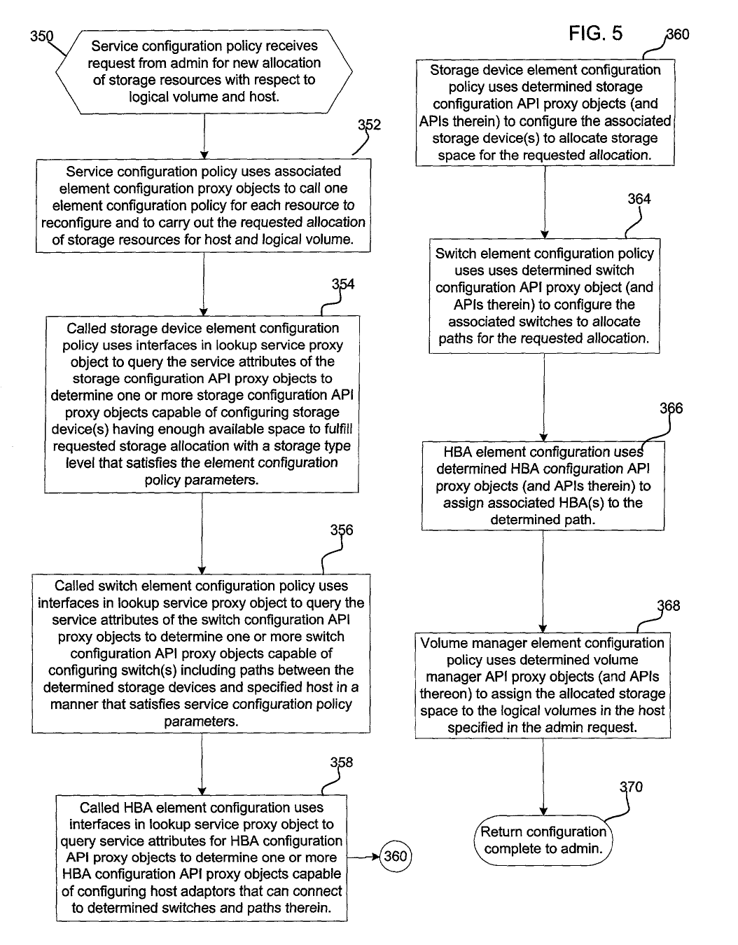

FIG. 5 illustrates logic implemented in the service configuration policy 202, 204 and element configuration policies 214a, b, c, 216a, b, c, 218a, b, c, 220a, b, c to perform the requested configuration operation. Control begins at block 350 when the service configuration policy 202, 204 receives a request from the administrator UI 252 for a new allocation of storage space for a logical volume and host through the configuration policy service proxy object 238, 240. In response, the selected service configuration policy 202, 204 calls (at block 352) one associated element configuration policy proxy object for each resource 222, 224, 226, 228 that needs to be configured to implement the allocation. In the logic described at blocks 354 to 370, the service configuration policy 202, 204 configures the following resources, the storage device 230, switch 232, host bus adaptors 234, and volume manager 236 to carry out the requested allocation. Additionally, the service configuration policy 202, 204 may call elements to configure more or less resources. For instance, for certain configurations, it may not be necessary to assign an additional path to the storage device for the added space. In such case, the service configuration policy 202, 204 would only need to call the storage device element configuration 214a, b, c and volume manager element configuration 220a, b, c to implement the requested allocation.

At block 354, the called storage device element configuration 214a, b, c uses interfaces in the lookup service proxy object 254 to query the resource capabilities of the storage configuration APIs 222 for storage devices 230 in the system to determine one or more storage configuration API proxy objects capable of configuring storage device(s) 230 having enough available space to fulfill requested storage allocation with a storage type level that satisfies the element configuration policy parameters. For instance, the gold service configuration policy 202 will call device element configuration policies that provide for redundancy, such as RAID 5 and redundant paths to the storage space, whereas the bronze service configuration policy may not require redundant paths or a high RAID level.

The called switch element configuration 216a, b, c uses (at block 356) interfaces in the lookup service proxy object 254 to query the resource capabilities of the switch configuration API proxy objects to determine one or more switch configuration API proxy objects capable of configuring switch(s) 132 including paths between the determined storage devices and specified host in a manner that satisfies the called switch element configuration policy parameters. For instance, the gold service configuration policy 202 may require redundant paths through the same or different switches to improve availability, whereas the bronze service configuration policy 200 may not require redundant paths to the storage device.

The called HBA element configuration policy 218a, b, c uses (at block 358) interfaces in lookup service proxy object 254 to query service attributes for HBA configuration API proxy objects to determine one or more HBA configuration API proxy objects capable of configuring host bus adaptors 234 that can connect to the determined switches and paths that are allocated to satisfy the administrator request.

Note that the above determination of storage devices, switches and host bus adaptors may involve the called device element configuration policies and the topology database performing multiple iterations to find some combination of available components that can provide the requested storage resources and space allocation to the specified logical volume and host and additionally satisfy the element configuration policy parameters.

After determining the resources 230, 232, and 234 to use to fulfill the administrator UI's 252 storage allocation request, the called device element configuration policies 214a, b, c, 216a, b, c, 218a, b, c, and 220a, b, c call the determined configuration APIs to perform the user requested allocation. At block 360, the previously called storage device element configuration policy 214a, b, c uses the one or more determined storage configuration API proxy objects 224, and the APIs therein, to configure the associated storage device(s) to allocate storage space for the requested allocation. At block 364, the switch element configuration 216a, b, c uses the one or more determined switch configuration API proxy objects, and APIs therein, to configure the associated switches to allocate paths for the requested allocation.

At block 366, the previously called HBA element configuration 218a, b, c uses the determined HBA configuration API proxy objects, and APIs therein, to assign the associated host bus adaptors 234 to the determined path.

At block 368, the volume manager element configuration policy 220a, b, c uses the determined volume manager API proxy objects, and APIs therein, to assign the allocated storage space to the logical volumes in the host specified in the administrator UI request.

The configuration APIs 222, 224, 226, 228, may grant element configuration policies 214a, b, c, 216a, b, c, 218a, b, c, 220a, b, c access to the API resources on an exclusive or non-exclusive basis according to the lease policy for the configuration API proxy objects.

The described implementations thus provide a technique to allow for automatic configuration of numerous SAN resources to allocate storage space for a logical volume on a specified host. In the prior art, users would have to select components to assign to an allocation and then separately invoke different configuration tools for each affected component to implement the requested allocation. With the described implementation, the administrator UI or other entity need only specify the new storage allocation one time, and the configuration of the multiple SAN components is performed by singularly invoking one service configuration policy 200, 202, that then invokes the device element configuration policies.

Using a Defined Service Configuration Policy to Implement a Resource Allocation

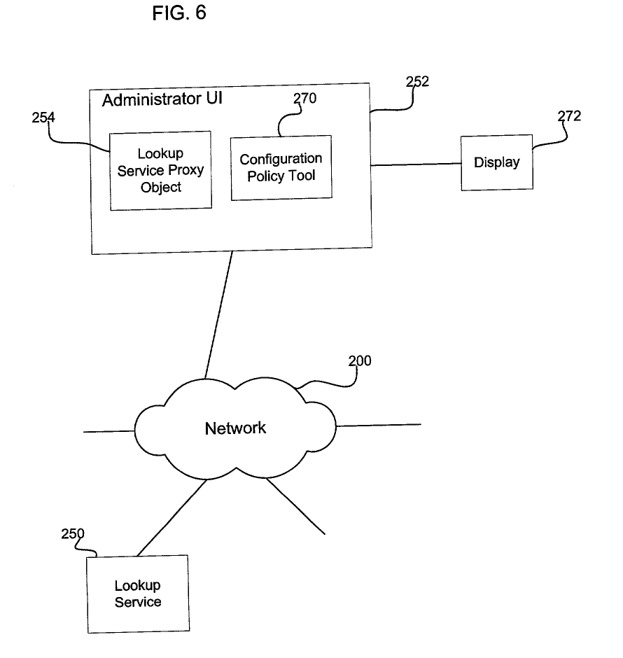

FIG. 6 illustrates further details of the administrator UI 252 including the lookup service proxy object 254 shown in FIG. 3. The administrator UI 252 further includes a configuration policy tool 270 which comprises a software program that a system administrator may invoke to define and add service configuration policies and allocate storage space to a host bus adaptor (HBA) according to a predefined service configuration policy. A display monitor 272 is used by the administrator UI 252 to display a graphical user interface (GUI) generated by the configuration policy tool 270.

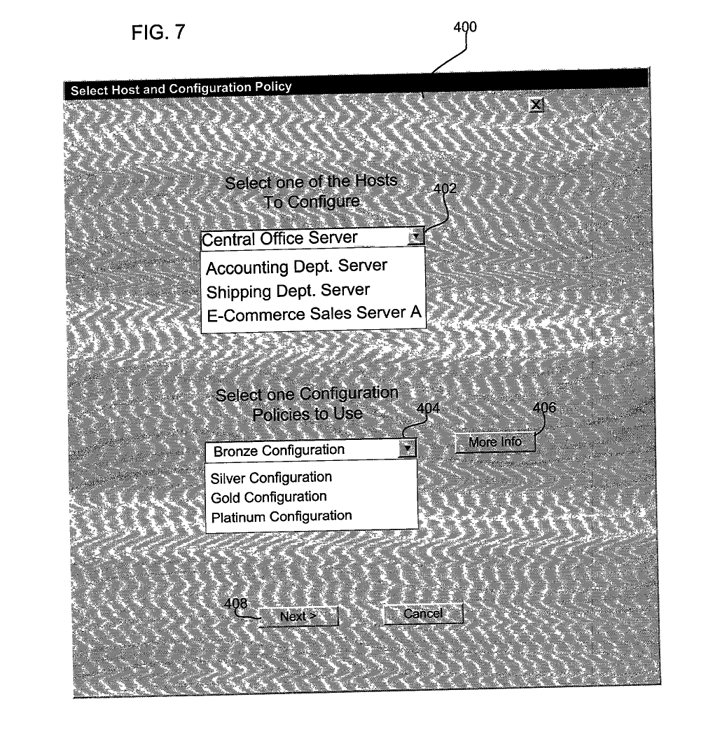

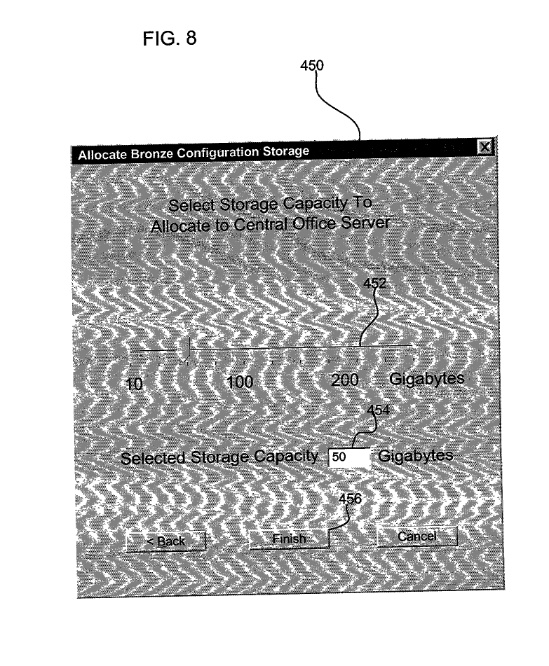

FIGS. 7-8 illustrate GUI panels the configuration policy tool 270 displays to allow the administrator UI to operate one of the previously defined service configuration policies to configure and allocate (provision) storage space. FIG. 7 is a GUI panel 400 displaying a drop down menu 402 in which the administrator may select one host including one or more bus adaptors (HBA) in the system for which the resource allocation will be made. A descriptive name of the host or any other name, such as the world wide name, may be displayed in the panel drop down menu 402. After selecting a host, the administrator may select from drop down menu 404 a predefined configuration service policy to use to configure the selected host, e.g., bronze, silver, gold, platinum, etc. Each configuration service policy 200, 202 displayed in the menu 404 has a proxy object 238 registered with the lookup service 250 (FIG. 3). The administrator may obtain more information about the configuration policy parameters for the selected configuration policy displayed in the drop down menu 404 by selecting the “More Info” button 406. The information displayed upon selection of the “More Info” button 406 may be obtained from the service attributes included with the proxy objects 238 for the service configuration policies.

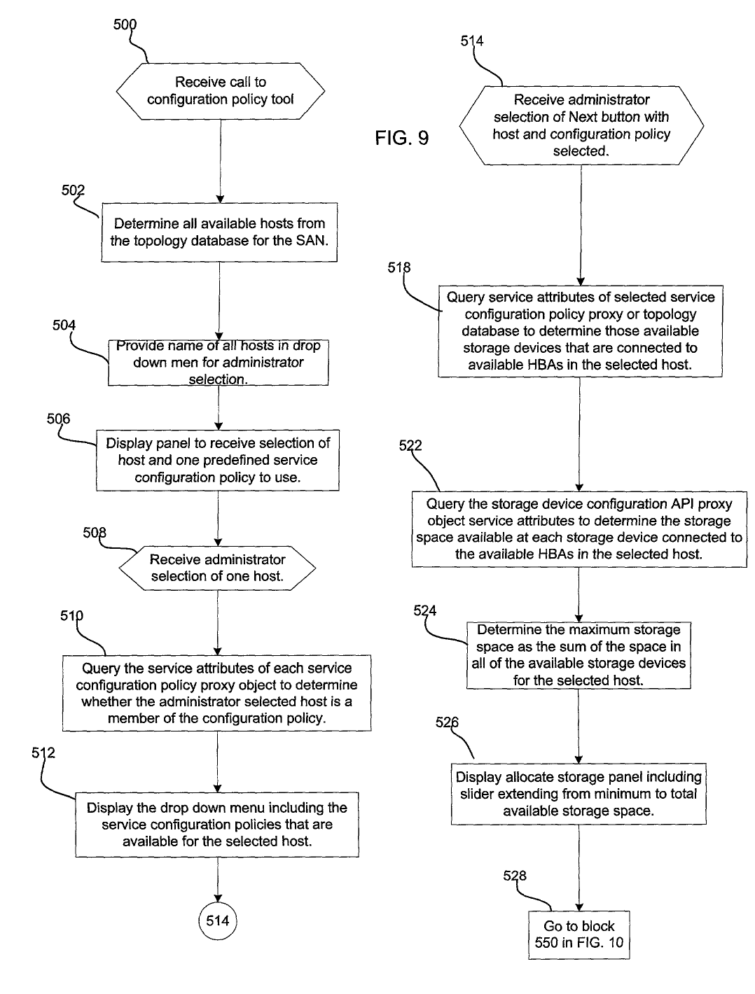

If the administrator selects one host in drop down menu 402, then the configuration policy tool 270 may determine, according to the logic described below with respect to FIG. 9, those service configuration policies 238 that can be used to configure the selected available (free) resources and their resource capabilities, and only display those determined service configuration policies in the drop down menu 404 for selection. Alternatively, the administrator may first select a service configuration policy 200,202 in drop down menu 404, and then the drop down menu 402 would display those hosts that are available to be configured by the selected service configuration policy 200, 202, i.e., those hosts that include an available host bus adaptor (HBA) connected to available resources, e.g., a switch and storage device, that can satisfy the configuration policy parameters 124 of the element configuration policies 106 (FIG. 2), 214a, b, c, 216a, b, c, 218a, b, c, 220a, b, c (FIG. 3), included in the selected service configuration policy.

After a service configuration policy and host are selected in drop down menus 402 and 404, the administrator may then select the Next button 408 to proceed to the GUI panel 450 displayed in FIG. 8. The panel 450 displays a slider 452 that the administrator may control to indicate the amount of storage space to allocate to the previously selected host according to the selected service configuration policy. The maximum selectable storage space on the slider 452 is the maximum available for the storage resources that may be configured for the selected host and configuration policy. The minimum storage space indicated on the slider 452 may be the minimum increment of storage space available that complies with the selected service configuration policy parameters. Panel 450 further displays a text box 454 showing the storage capacity selected on the slider 452. Upon selection of the amount of storage space to allocate using the slider 452 and the Finish button 456, the configuration policy tool 270 would then invoke the selected service configuration policy to allocate the administrator specified storage space using the host and resources the administrator selected.

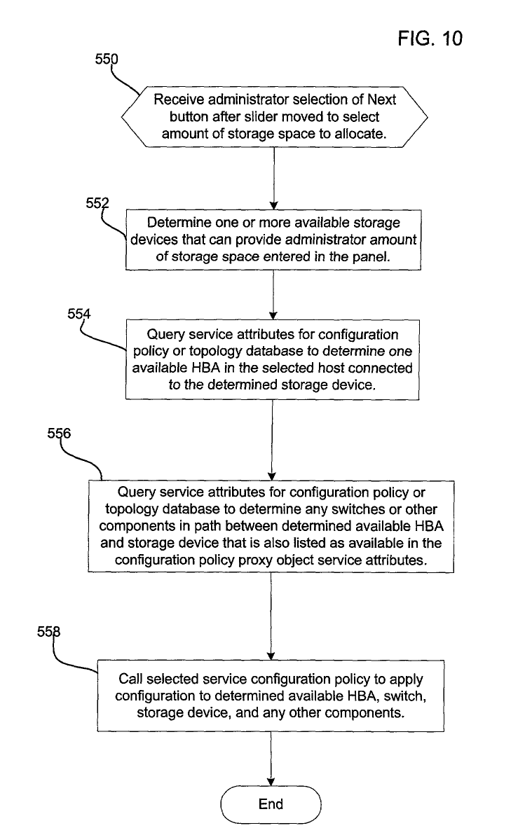

FIGS. 9 and 10 illustrate logic implemented in the configuration policy tool 270 and other of the components in the architecture described with respect to FIGS. 2 and 3 to allocate storage space according to a selected predefined service configuration policy. With respect to FIG. 9, control begins at block 500, where the configuration policy tool 270 is invoked by the administrator UI 252 to allocate storage space. The configuration policy tool 270 then determines (at block 502) all the available hosts in the system using the topology database 140 (FIG. 2), 256 (FIG. 3). Alternatively, the configuration policy tool 270 can use the lookup service proxy object 254 to query the resource capabilities of the proxy objects for the HBA configuration APIs and the topology database to determine the name of all hosts in the system that have available HBA resources. A host may include multiple host bus adaptors 234. The name of all the determined hosts are then provided (at block 504) to the drop down menu 402 for administrator selection. The configuration policy tool 270 then displays (at block 506) the panel 400 (FIG. 7) to receive administrator selection of one host and one predefined service configuration policy 200, 202 to use to configure the host.

Upon receiving (at block 508) administrator selection of one host, the configuration policy tool 270 then queries (at block 510) the service attributes 130 (FIG. 2) of each service configuration policy proxy object 120 (FIG. 2), 238 (FIG. 3) to determine whether the administrator selected host is available for the service configuration policy, i.e., whether the selected host includes a host bus adaptor (HBA) arrangement that can satisfy the requirements of the selected service configuration policy 200, 202. As discussed the service attributes 130 of the configuration policy proxy objects 120 (FIG. 2) provide information on all the resources in the system that may be used and configured by the configuration policy. Alternatively, information on the topology of available resources for the host may be obtained by querying the topology database 256, and then a determination can be made as to whether the resources available to the host as indicated in the topology database 256 are capable of satisfying the configuration policy parameters. Still further, a determination can be made of those resources available to the host as indicated in the topology database 256 that are also listed in the service attributes 130 of the service configuration policy proxy object 120 indicating resources capable of being configured by the service configuration policy 108 represented by the proxy object. The configuration policy tool 270 then displays (at block 512) the drop down menu 404 with the determined service configuration policies that may be used to configure one host bus adaptor (HBA) 234 in the host selected in drop down menu 402 (FIG. 7)

Upon receiving (at block 514) administrator selection of the Next button 408 (FIG. 7) with one host and service configuration policy 200, 202 selected, the configuration policy tool 270 then uses the lookup service proxy object 254 to query (at block 518) the service attributes 130 of the selected service configuration policy proxy object 120 (FIG. 2), 238 (FIG. 3) to determine all the host bus adaptors (HBA) available to the selected service configuration policy that are in the selected host and the available storage devices 230 attached to the available host bus adaptors (HBAs) in the selected host. As discussed, such information on the availability and connectedness or topology of the resources is included in the topology database 140 (FIG. 2), 256 (FIG. 3). The configuration policy tool 270 then queries (at block 522) the resource capabilities in the storage device configuration API proxy object 242 to determine the allocatable or available storage space in each of the available storage devices connected to the host subject to the configuration. The total available storage space across all the storage devices available to the selected host is determined (at block 524). The storage space allocated to the host according to the configuration policy may comprise a virtual storage space extending across multiple physical storage devices. The allocate storage panel 450 (FIG. 8) is then displayed (at bock 526) with the slider 452 having as a maximum amount the total storage space in all the available storage devices connected to the host and a minimum increment amount indicated in the the configuration policy 108, 202 or the configuration policy parameters for the storage device element configuration 214a, b, c (FIG. 3) for the selected configuration policy. Control then proceeds to block 550 in FIG. 10.

Upon receiving (at block 550) administrator selection of the Finish button 456 after administrator selection of an amount of storage space using the slider, the configuration policy tool 270 then determines (at block 552) one or more available storage devices that can provide the administrator selected amount of storage. At block 522, the amount of storage space in each available storage device was determined. The configuration policy tool 270 then queries (at block 554) the service attributes of the selected service configuration policy proxy object 238 and the topology database to determine the available host bus adaptor (HBA) in the selected host that is connected to the determined storage device 230 capable of satisfying the administrator selected space allocation. The service attributes are further queried (at block 556) to determine one or more switches in the path between the determined available host bus adaptor (HBA) and the determined storage device. If the selected service configuration policy requires redundant hardware components, then available redundant resources would also be determined. After determining all the resources to use for the allocation that connect to the selected host, the one element configuration policy 218a, b, c, 216a, b, c, 214a, b, c, or 220a, b, c is called (at block 558) to configure the determined resources, e.g., HBA, switch, storage device, and any other components.

In the above described implementation, the administrator only made one resource selection of a host. Alternatively, the administrator may make additional selections of resources, such as select the host bus adaptor (HBA), switch and/or storage device to use. In such case, upon administrator selection of one additional component to use, the configuration policy tool 270 would determine from the service attributes of the selected service configuration policy the available downstream components that is connected to the previously selected resource instances. Thus, administrator or automatic selection of an additional component is available for use with a previous administrator selection.

The above described graphical user interfaces (GUI) allows the administrator to make the minimum necessary selections, such as a host, service configuration policy to use, and storage space to allocate to such host. Based on these selections, the configuration policy tool 270 is able to automatically determine from the registered proxy objects in the look service the resources, e.g., host bus adaptor (HBA), switch, storage, etc., to use to allocate the selected space according to the selected configuration policy without requiring any further information from the administrator. At each step of the selection process, the underlying program components query the system for available resources or options that satisfy the previous administrator selections.

Dynamically Creating a Service Quality Configuration Policy

In certain situations, a systems administrator may want to configure resources according to a pre-defined configuration policy. In other words, the administrator may not be interested in using an already defined configuration policy and, may instead, want to design a configuration policy that satisfies certain service level metrics, such as performance, availability, throughput, latency, etc.

To allow the administrator to configure storage by specifying service level attributes (such as service level metrics), including performance and availability attributes, the service attributes 128a . . . n (FIG. 2) of the element configuration proxy objects 118a . . . n would include the rated and/or field capabilities of the resource (e.g., storage device 230, switch 232, HBA, 234, etc.) that results from the element configuration policy 106 configuring the resource 112. Such field capabilities include, but are not limited to, availability and performance metrics. The field capabilities may be determined from field data gathered from customers, beta testing and in the design laboratory during development of the element configuration policy 106. For instance, the service attributes for the storage device element configuration policy 214a, b, c (FIG. 3) may indicate the level of availability/redundancy resulting from the configuration, such as the number of disk drives in the storage space that can fail and still allow data recovery, which may be determine by a RAID level of the configuration. The service attributes for the switch device element configuration policies 216a, b, c may indicate the availability resulting from the switch configurations, such as whether the configuration results in redundant switch components and the throughput of the switch. The service attributes for the HBA element configuration policies 218a, b, c may indicate any redundancies in the configuration. The service attributes for each element configuration policy may also indicate the particular resources or components that can be configured to that configuration policy, i.e., the resources that are capable of being configured by the particular element configuration policy and provide the performance, availability, throughput, and latency attributes indicated in the service attributes for the element configuration.

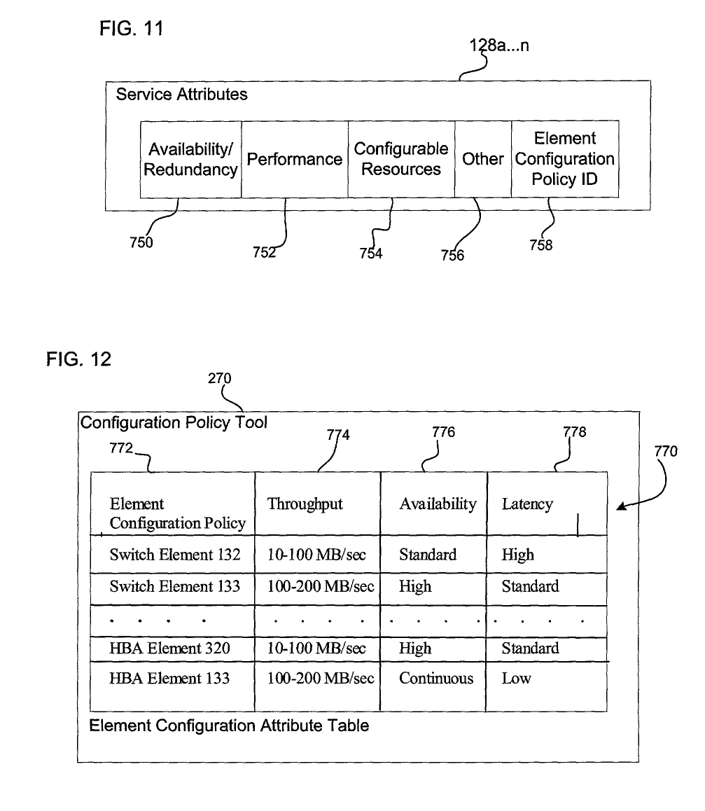

FIG. 11 illustrates data maintained with the element configuration service attributes 128a . . . n, including an availability/redundancy field 750 which indicates the redundancy level of the element, which is the extent to which failure can be tolerated and the device still function. For instance, for storage devices, the data redundancy would indicate the number of copies of the data which can be accessed in case of failure, thus increasing availability. For instance, the availability service attribute may specify “no single point of failure”, which can be implement by using redundant storage device components to ensure continued access to the data in the event of a failure of a percentage of the storage devices. Note, that there is a direct correlation between redundancy and availability in that the greater the number of redundant instances of a component, the greater the chances of data availability in the event that one component instance fails. For switches, host bus adaptors and other resources, the availability/redundancy may indicate the extent to which redundant instances of the resources, or subcomponents therein, are provided with the configuration. The performance field 752 indicates the performance of the resource. For instance, if the resource is a switch, the performance field 752 would indicate the throughput of the switch; if the resource is a storage device, the performance field 752 may indicate the I/O transaction rate. The configurable resources field 754 indicates those particular resource instances, e.g., specific HBAs, switches, and storage devices, that are capable of being configured by the particular element configuration policy to provide the requested performance and availability/redundancy attributes specified in the fields 750 and 752. The other fields 756, which are optional, indicates one or more other performance related attributes, e.g., latency. The element configuration policy ID field 758 provides a unique identifier of the element configuration policy that uses the service attributes and configuration parameters.

Those skilled in the art will appreciate that service attributes can specify different types of performance and availability metrics that result from the configuration provided by the element configuration policies 214a, b, c, 216a, b, c, 218a, b, c, 220a, b, c identified by the element configuration policy ID, such as bandwidth, I/O rate, latency, etc.

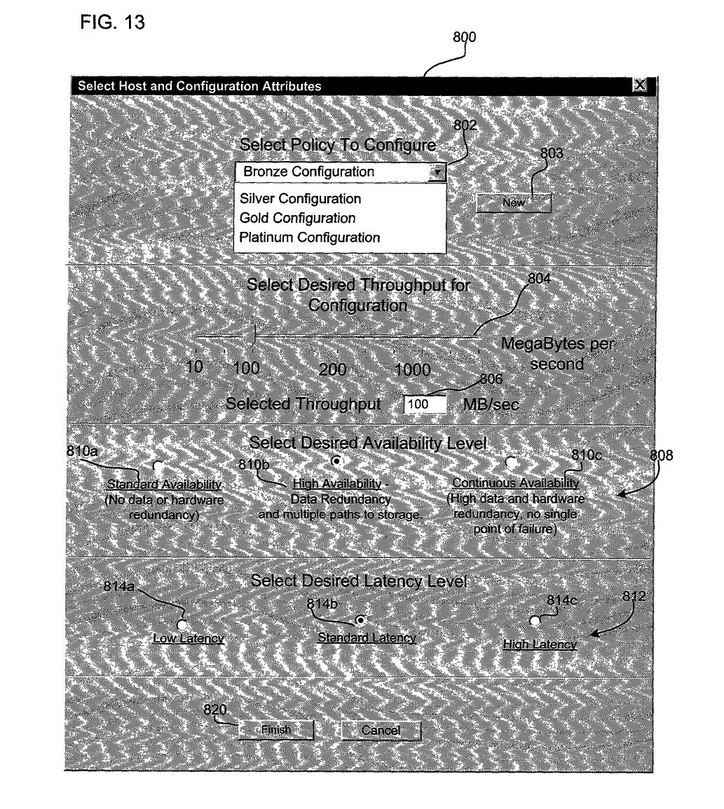

FIG. 12 illustrates further detail of the administrator configuration policy tool 270 including an element configuration policy attribute table 770 that includes an entry for each element configuration policy indicating the service attributes that result from the application of each element configuration policy 772. For each element configuration policy 772, the table 770 provides a description of the throughput level 774, the availability level 776, and the latency level 778. These service level attributes implemented by the element configuration policies listed in the attribute table 770 may also be found in the service attributes 128a, b . . . n (FIGS. 2 and 11) associated with the element configuration policy proxy objects 118a, b . . . n. The element configuration policy attribute table 770 is updated whenever an element configuration policy 214a, b, c, 216a, b, c, 218a, b, c, 220a, b, c (FIG. 3) is added or updated. The element configuration attribute table 770 may be stored in a file external or internal to the configuration policy tool 270. For instance, the table 770 may be maintained in the lookup service 110, 250 and accessible as a registered proxy object.

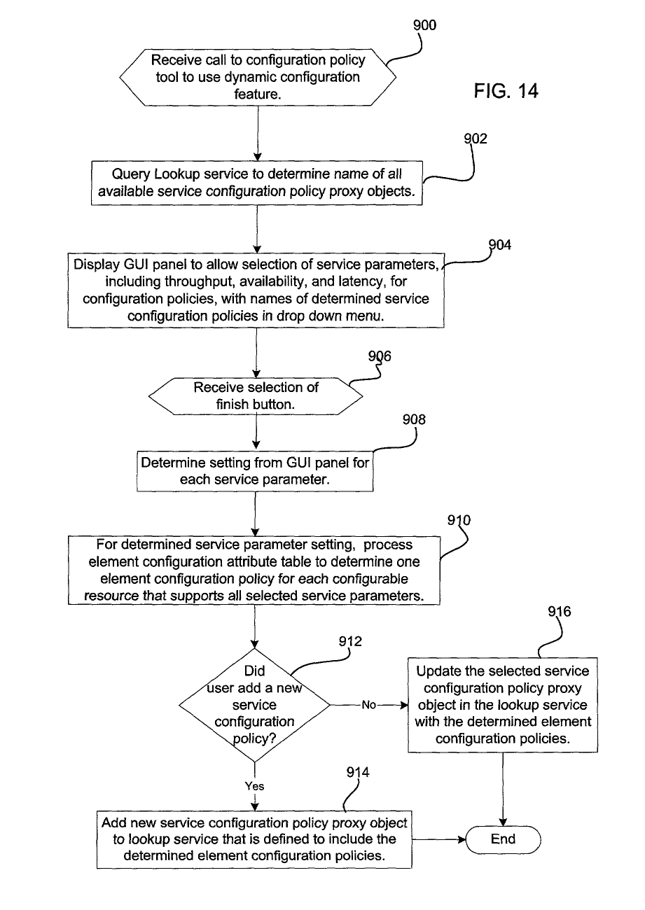

FIG. 13 illustrates a graphical user interface (GUI) panel 800 through which the system administrator would select an already defined configuration policy 200, 202 (FIG. 3) from the drop down menu 802 to adjust or to add a new configuration policy by selecting the New button 803. After selecting an already defined or new configuration policy to configure, the administrator would then select the desired availability, throughput (I/Os per second), and latency attributes of the configuration. The slider bar 804 is used to select the desired throughput for the configuration in terms of megabytes per second (Mb/sec). The selected throughput is further displayed in text box 806, and may be manually entered therein. In the availability section 808, the administrator may select one of the radio buttons 810a, b, c to implement a predefined availability level. Each of the selectable availability levels 810a, b, c corresponds to a predefined availability configuration. For instance, the standard availability level 810a may specify a RAID 0 volume with no guaranteed data or hardware redundancy; the high availability 810b may specify some level of data redundancy, e.g., RAID 1 to RAID 5, possible hot sparing, and path redundancy from host to the storage. The continuous availability 810c provides all the performance benefits of high availability and also requires hardware redundancy so that there are no single points of failure anywhere in the system.

Moreover, to improve availability during backup operations, a snapshot program tool may be used to make a copy of pointers to the data to backup. Later during non-peak usage periods, the data addressed by the pointers is copied to a backup archive. Using the snapshot to create a backup by creating pointers to the data increases availability by allowing applications to continue accessing the data when the backup snapshot is made because the data being accessed is not itself copied. Still further, a mirror copy of the data may be made to provide redundancy to improve availability such that in the event of a system failure, data can be made available through the mirror copy. Thus, snapshot and mirror copy elements may be used to implement a configuration to ensure that user selected availability attributes are satisfied.

In the latency section 812, the administrator may select one of the radio buttons 814a, b, c to implement a predefined latency level for a predefined latency configuration. The low latency 814a indicates a low level of delay and the high latency 816 indicates a high level of component delay. For instance, the network latency indicates the amount of time for a packet to travel from a source to destination and includes storage device latency indicates the amount of time to position the read/write head to the correct location on the disk. A selection of low latency for a storage device can be implemented by providing a cache in which requested data is stored to improve the response time to read and write requests for the storage device. In additional implementations, sliders may be used to allow the user to select the desired data redundancy as a percentage of storage resources that may fail and still allow data to be recovered.

After selecting the desired service parameters for a new or already defined service configuration policy, the administrator would then select the Finish button 820 to update a preexisting service configuration policy selected in the drop down menu 802 or generate the service configuration policy that may then later be selected and used as described with respect to FIG. 7.

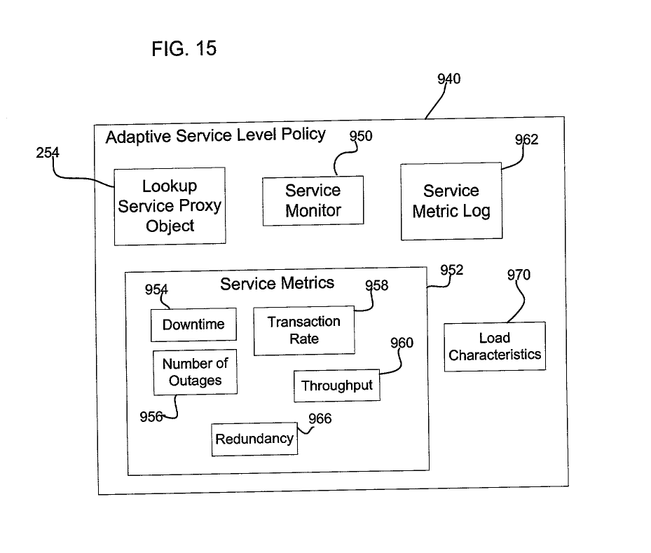

FIG. 14 illustrates logic implemented in the administrator configuration policy tool 270 (FIG. 6) to utilize the GUI panel 800 in FIG. 13 as well as the element configuration attribute table 770 to enable an administrator to provide a dynamic configuration based on administrator selected throughput, availability, latency, and any other performance parameters. Control begins at block 900 with the administrator invoking the configuration policy tool 270 to use the dynamic configuration feature. The configuration policy tool 270 queries (at block 902) the lookup service 110, 250 (FIGS. 2 and 3) to determine all of the service configuration policy proxy objects 238, such as the gold quality service 202, bronze quality service 200, etc. The GUI panel 800 in FIG. 13 is then displayed (at block 904) to enable the administrator to select the desired throughput, availability level, and latency for a new service configuration policy or one of the service configuration policy determined from the lookup service that is accessible through the drop down menu 802. If the user selects one of the already defined service configuration policies from the drop down menu 802, then, in certain implementations, the service level parameters as indicated in the element configuration attribute table 770 are displayed in the GUI panel 800 as the default service level settings that the user may then further adjust.

In response to receiving (at block 906) selection of the finish button 820, the configuration policy tool 270 determines all the service parameter settings in the GUI panel 800 (FIG. 13) for the throughput 804, availability 808, and latency 812, which may or may not have been user adjusted. For each determined service parameter setting for throughput 804, availability 808, and latency, the element configuration attribute table 770 is processed (at block 910) to determine the appropriate resources and one element configuration 214a, b, c, 216a, b, c, 218a, b, c, and 220a, b, c (FIG. 3), for each configurable resource, e.g., storage device 230, switch 232, HBA 226, volume manager program 236, etc., that supports all the determined service parameter settings. Such a determination is made by finding one element for each resource having column values 774, 776, and 778 in the element configuration attribute table 770 (FIG. 12) that match the determined service parameter settings in the GUI 800 (FIG. 13). If (at block 912) the administrator added a new service configuration policy by selecting the new button 803 (FIG. 13), then the configuration policy tool 270 would add a new service configuration policy proxy object 238 (FIG. 3) to the lookup service 250 that is defined to include the element configuration policies determined from the table 770. Otherwise, if an already existing service configuration policy, e.g., 200 and 202 (FIG. 3), is being updated, then the proxy object for the modified service configuration policy is updated with the newly determined element configuration policies that satisfy the administrator selected service levels.

Thus, with the described implementations the administrator selects desired service levels, such as throughput, availability, latency, etc., and the program then determines the appropriate resources and those element configuration policies that are capable of configuring the managed resources to provide the desired service level specified by the administrator.

Adaptive Management of Service Level Agreements

In additional implementations, a customer may enter into an agreement with a service provider for a particular level of service, specifying service level parameters and thresholds to be satisfied. For instance, a customer may contract for a particular service level, such as bronze, silver, gold or platinum storage service. The service level agreement will identify certain target goals or threshold objectives, such as a minimum bandwidth threshold, a maximum number of service outages, a maximum amount of down time due to service outages, etc. The initial configuration may comprise a configuration policy selected using the dynamic configuration technique described above with respect to FIGS. 11-14.

During operation, the user may find that the initial configuration is unsatisfactory due to changing service loads that prevent the system from meeting the service levels specified in the service level agreement. The service levels specified in the agreement require that the system load remain in certain ranges. If the load exceeds such ranges, then the current service may no longer be able to maintain the service levels specified in the contract. The described implementations concern techniques to adjust the resources included in the service to accommodate changes in the service load. For instance, the customer may specify that downtime not exceed a certain threshold. One threshold may comprise a number of instances of planned downtime or outages, such that compliance with the service level agreement means that no more than a specified number of downtime instances or a specified downtime duration will occur.

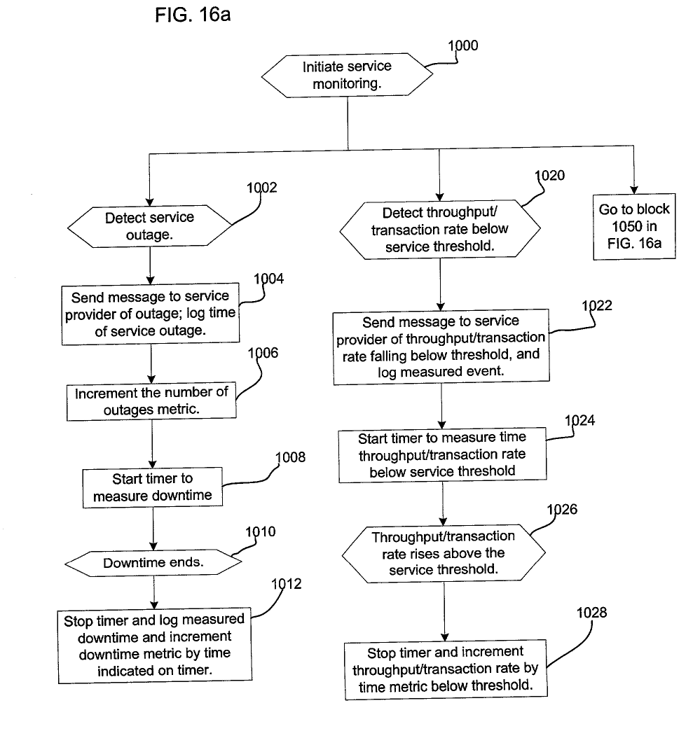

As shown in FIG. 15, the adaptive service level policy program 940 includes a service level monitor program 950 that monitors service level metrics indicating actual performance of system resources, such as throughput, transaction rate, downtime, number of outages, etc., to determine whether the measured service level parameters satisfy the service level specified by the service level agreement. The service monitor 950 gathers service metrics 952 by continuously monitoring the system for specific monitoring periods. The service metrics 952 include:

Downtime 954: cumulative amount of time the system has been “down” or unavailable to the application or host 4, 6 (FIG. 3) during the monitoring period.

Number of Outages 956: number of outage instances where applications have been unable to connect to the network 200 during the monitoring period.

Transaction Rate 958: is cumulative time the measured transaction rate or I/Os per second is below threshold during monitoring period. Transaction rate is different from throughput, which is measured in megabytes (MB) per second.

Throughput 960: is the cumulative time the measured system throughput of data transfers between hosts 4, 6 and storage devices 8, 10 is below a threshold during the monitoring period. The throughput considers the amount of time the level of service is below the threshold for the monitored time period.

Redundancy 966: is the cumulative time that resource redundancy has remained below an agreed upon threshold due to a failure of the service provider to repair a failed resource.

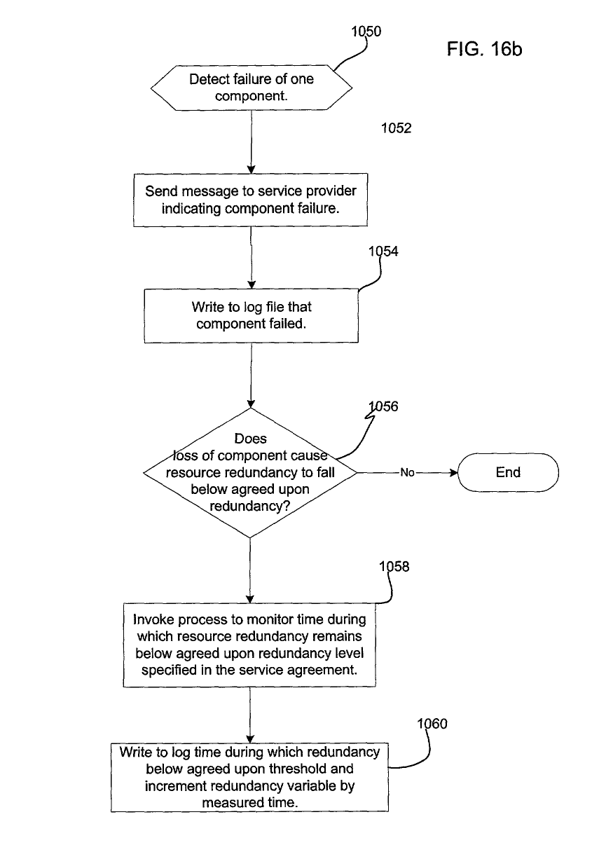

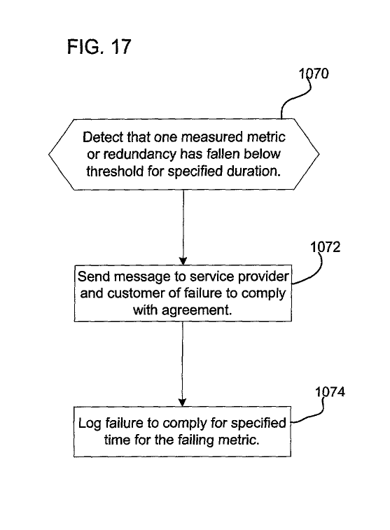

The service monitor 950 would write gathered service metric data 952 along with a timestamp of when the attributes were measured to a service metric log 962. FIGS. 16a, 16b, and 17 illustrate logic implemented in the service monitor 950 to monitor whether service metrics 952 are satisfying service level parameters defined for a particular service level configuration, which may be specified in a service level agreement with a customer. As discussed, the service level agreement specifies certain service levels for any one of the following service attributes, such as downtime, number of outages, throughput, transaction rate, redundancy, etc. With respect to FIG. 16a, service monitoring is initiated at block 1000 for a session. As part of service monitoring, upon detecting (at block 1002) a service outage in which hosts 4, 6 cannot access storage devices 8, 10 (FIG. 1), the service monitor 950 sends (at block 1004) a message to the service provider of the outage and logs the time of the service outage to the service metric log 962. The number of outages 956 variable is incremented (at block 1006) and a timer is started (at block 1008) to measure the duration of downtime. When the downtime period ends (at block 1010), i.e., hosts can again access the storage resources, the timer is stopped (at block 1012), the downtime 954 is incremented by the measured downtime and the measured downtime is logged in the service metric log 962.

In addition to monitoring outages, throughput and transaction rates are measured. Upon detecting (at block 1020) that throughput and/or the transaction rate fall below an agreed upon service objective, a message is sent (at block 1022) notifying the service provider that the throughput and/or transaction rate has fallen below a service threshold and logs the measured event in the service metric log 962. At block 1024, the adaptive service level policy 940 starts a timer to measure the time during which throughput/transaction rate is below the service threshold. When the throughput and/or transaction rate that was detected below the service threshold rises above the service threshold (at block 1026), then the timer is stopped (at block 1028) and the transaction rate 958 and/or throughput 960 is incremented by the time the time the metric was measured below the service threshold.

After initiating the service monitoring, the service monitor 950 further monitors to detect a failure of one component at block 1050 in FIG. 16b. In certain implementations, resource redundancy may be incorporated into the service level agreement by specifying no single point of failure. Upon detecting a component failure (at block 1050), a message is sent (at block 1052) to notify the service provider of the component failure. The log is updated (at block 1054) to indicate that the detected component failed. If (at block 1056) the loss of the component causes the resource redundancy to fall below an agreed upon redundancy level in the service agreement, e.g., no single point of failure in the system, then control proceeds to block 1058 to invoke a process to monitor the time during which the redundancy remains below the agreed upon resource redundancy level specified in the service agreement. The service monitor 950 writes (at block 1060) to the log the time during which the redundancy is below the agreed upon threshold and increments the redundancy variable 966 by the time during which redundancy was below the agreed upon threshold.

FIG. 17 illustrates logic implemented in the service monitor 950 at any time during the service monitoring that was invoked at block 1000 in FIG. 16a. At block 1070, the service monitor 950 detects that one measured metric and/or the redundancy has fallen below the threshold for the time period specified in the service level agreement. This time is detected by adding the amount of time of the timer to the current value of the metric 954, 956, 958, 960, and 966 and comparing the result with the time period specified in the agreement. As discussed, the service level agreement may specify that a time period with a service parameter threshold, such that the agreement is not satisfied if the measured service parameter or redundancy falls below an agreed upon threshold longer than the agreed upon time period. The time period provides time to allow the adaptive service level policy program 940 to troubleshoot and remedy the problem causing the performance or availability shortcomings and account for momentary load changes that have only a temporary effect on performance. A message is sent (at block 1072) notifying both the service provider and the customer of the failure to comply with the agreed upon service parameter for a duration longer than the specified time. This failure to comply is further logged (at block 1074) in the service metric log 962.

During periodic intervals, the service monitor 950 further measures the load characterization. Load characterization is measured separate from the metrics and redundancy. Measured load characterizations include average I/O block size, percent of I/Os that are random versus sequential, the percent of I/Os that are read versus write, etc. This information is time stamped and logged in a separate load characterization log. Load characterization may also be computed into average values for use when the thresholds are not being met. The load characterization is not part of a service level metric, but represents the characteristics of how the application is using the storage. Measured load characterization is written to the load characteristics log 970.

With the logic of FIGS. 16a, 16b, and 17, notification is initially sent only to the service provider upon detecting the measured service parameter below the threshold so that the service provider can take corrective action to troubleshoot and fix the system before the timer expires so that the level of service does not breach the service level agreement. At this point, the customer need not know because technically there is no failure to comply with the service level agreement until the time period has expired. However, if no time period is provided for the service parameter, then a message is sent to both the customer and service provider because the service level agreement does not provide time for the service provider to remedy the problem before non-compliance of the service level agreement occurs.

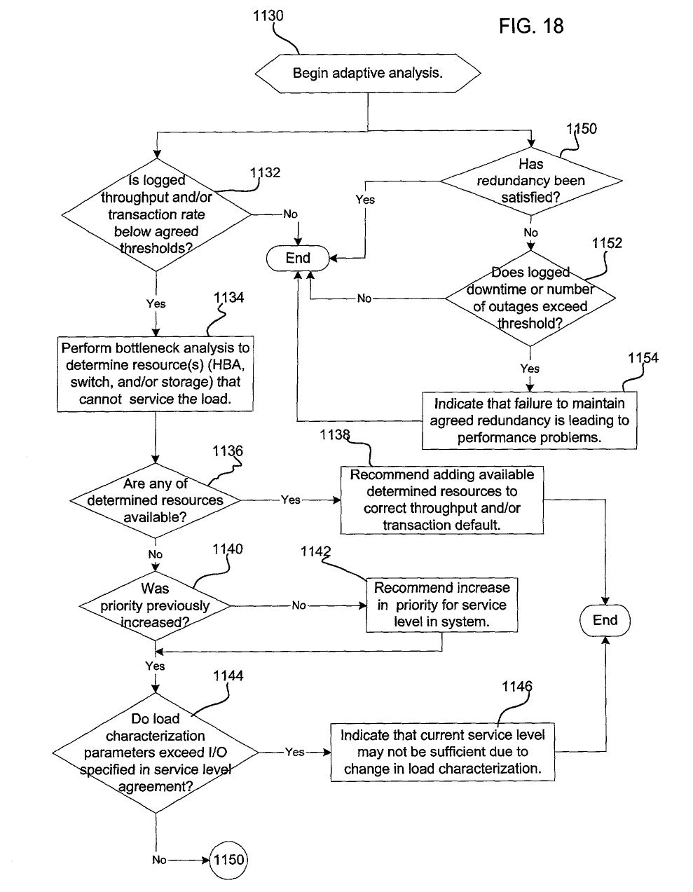

After detecting that service levels specified in a service agreement have not been satisfied, the adaptive service level policy 940 implements the logic of FIG. 18 to consider the load characterization and the agreed upon load characterization to determine the appropriate course of action, such as to suggest allocating additional resources to the service to remedy the failure to satisfy service levels. As discussed, the service level agreement will specify a load characterization, or I/O profile, intended for the resource allocation. This agreed upon I/O profile that is monitored may include the following load characteristics:

Workload: specifies an estimated read to write ratio.

Access Pattern: indicates whether the application using the storage space accesses the data randomly or sequentially.

Input/Output (I/O) size: a range of the I/O size.

The service monitor 950 will measure the service metrics 952 specified in the service level agreement as well as the load characteristics 970 in regular intervals and compare measured values against values specified in I/O profile. FIG. 18 illustrates logic implemented in the adaptive service level policy 940 to recommend changes to the configuration based on the service metrics 952 and the load characteristics 970 measured by the service monitor 950. Control begins at block 1130 where the adaptive service level policy program 940 begins the adaptive analysis process after the service monitor 950 has measured service metrics 952 and load characteristics 970. If (at block 1132) the throughput 960 and/or the transaction rate 958 have fallen below the agreed upon threshold, as indicated in the log 962, then the adaptive service level policy 940 performs (at block 1134) a bottleneck analysis to determine one or more resources, such as HBAs, switches, and or storage that are having difficulty servicing the current load and likely the source of the failure of the throughput and/or transaction rate to satisfy threshold objectives. If (at block 1136) any of the determined resources are available, then the adaptive service level policy 940 recommends (at block 1138) adding the available determined resources to the service level to correct the throughput and/or transaction rate problem. If none of the determined resources are available, i.e., in an available storage pool, then a determination is made (at block 1140) whether the priority level for the service has already been increased. If not, then a recommendation is made (at block 1142) to increase priority for the service level in the system in the areas where resources are shared.

In certain implementations, different applications may operate at different service levels, such that different service levels, e.g., platinum, gold, silver, etc., apply to different groups of applications. For instance, a higher priority group of applications, such as accounting, financial management, sales applications, etc., may operate at a higher service level than other groups of applications in the organization, whose data access operations are less critical. In such case, the priority defined for the service would be configured into the resources so that the system resources, e.g., host adaptor card, switch, storage subsystem, etc., would prefer selecting the I/O requests from applications operating at a higher priority than for I/O requests originating from applications operating at a lower priority. In this way, requests from applications operating within a higher service level agreement will receive higher priority when processed by the system components. In implementations where priority is used, the priority level may be adjusted if the throughput and/or transaction rate is not meeting agreed upon levels so that resources give higher priority to the requests for that service whose priority is adjusted at block 1142.

Whether or not priority is adjusted, control proceeds to block 1144 where the adaptive service level policy 940 determines whether the load characterization parameters, e.g., workload, access pattern, I/O size, exceeds the I/O profile specified in the service level agreement. If the load characterization exceeds the load specified in the agreement, then the adaptive service level policy 940 indicates (at block 1146) that the current service level may not be sufficient due to the change in load characterization. In other words, to meet goals, the user may have to alter or upgrade their service level. If (at block 1144) the load characterization does not exceed the agreed upon I/O profile, then a determination is made (at block 1150) whether failure to maintain redundancy is leading to availability problems. If the redundancy has been satisfied, then control ends. Otherwise, if redundancy is not satisfied, then a determination is made (at block 1152) whether the failure to maintain agreed upon redundancy level is leading to downtime and performance problems. If so, indication is made (at block 1154) that failure to maintain redundancy is leading to performance problems because if the agreed upon redundant resources were available, then such resources could be deployed to improve the throughput and transaction rate and/or provide redundant paths to avoid downtime and outages. Otherwise, if (at block 1152) the logged downtime and number of outages meets agreed upon levels, control ends.

In addition to checking the throughput and transaction rate performance, the adaptive service level policy 940 also determines at blocks 1150, 1152, and 1154 whether failure to maintain redundancy is leading to availability problems.

The result of the logic of FIG. 18 is a series of one or more recommendations on corrective action to be taken if any of the service metrics 952 do not meet agreed upon service levels.

The suggested fixes indicated as a result of the decisions made in FIG. 18 may be implemented automatically by the adaptive service level policy 940 by calling one or more configuration tools to implement the indicated changes. Alternatively, the adaptive service level policy 940 may generate a message to an operator indicating the suggested modifications of resources to bring performance and/or availability back in line with the service levels specified in the service level agreement. The operator can then decide to invoke a configuration tool, such as the configuration policy tool 270 discussed above, to allocate available resources as determined by the adaptive service level policy 940 according to the logic of FIG. 18, or the operator can implement a different configuration.

The described implementations thus provide a technique for monitoring system resources and for recommending a modification in the resource configuration based on the result of the monitored service parameters. In the logic of FIG. 18, the adaptive service level policy 940 may suggest any type of modification to address the failure of the measured service parameters to comply with agreed upon levels. For instance, the service monitor 950 may suggest to reconfigure a resource, add resources if additional resources are available, reallocate resources, or change the priority of requests for applications operating under the service level agreement in a multi service level environment. For instance, to modify a storage resource, additional space may be added, new storage configurations may be set. For RAID storage, the stripe size, stripe width, RAID level, etc. may be changed. For a switch resource, additional ports may be configured, a switch added, etc.

Additional Implementation Details

The described implementations may be realized as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments of the configuration discovery tool are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The described implementations presented GUI panels including an arrangement of information and selectable items. Those skilled in the art will appreciate that there are many ways the information and selectable items in the illustrated GUI panels may be aggregated into fewer panels or dispersed across a greater number of panels than shown. Further, additional implementations may provide different layout and user interface mechanisms to allow users to enter the information entered through the discussed GUI panels. In alternative embodiments, users may enter information through a command line interface as opposed to a GUI.

FIGS. 18a, b presented specific checks of the current service metrics against various thresholds to determine the amount of additional resources to allocate. Those skilled in the art will recognize that numerous other additional checks and determinations may be made to provide further resource allocation suggestions based on the failure to meet a specific threshold.

The described implementations provided consideration for specific service metrics, such as downtime, available storage space, number of outages, etc. In additional implementations, additional service metrics may be considered in determining how to alter the allocation of resources to remedy failure to satisfy the service levels promised in the service level agreement.

The implementations were described with respect to the Sun Microsystems, Inc. Jiro network environment that provides distributed computing. However, the described technique for configuration of components may be implemented in alternative network environments where a client downloads an object or code from a server to use to access a service and resources at that server. Moreover, the described configuration policy services and configuration elements that were described as implemented in the Java programming language as Jiro proxy objects may be implemented in any distributed computing architecture known in the art, such as the Common Object Request Broker Architecture (CORBA), the Microsoft NET architecture**, Distributed Computing Environment (DCE), Remote Method Invocation (RMI), Distributed Component Object Model (DCOM), etc. The described configuration policy services and configuration elements may be coded using any known programming language (e.g., C++, C, Assembler, etc.) to perform the functions described herein. **JINI, JIRO, JAVA, SUN, and SUN MICROSYSTEMS are trademarks of Sun Microsystems, Inc. InfiniBand is a service mark of the InfiniBand Trade Association; MICROSOFT and NET are trademarks of Microsoft Corporation.

In the described implementations, the storage comprised network storage accessed over a network. Additionally, the configured storage may comprise a storage device directly attached to the host. The storage device may comprise any storage system known in the art, including hard disk drives, DASD, JBOD, RAID array, tape drive, tape library, optical disk library, etc.

The described implementations may be used to configure other types of device resources capable of communicating on a network, such as a virtualization appliance which provides a logical representation of physical storage resources to host applications and allows configuration and management of the storage resources.

The described logic of FIGS. 4 and 5 concerned a request to add additional storage space to a logical volume. However, the above described architecture and configuration technique may apply to other types of operations involving the allocation of storage resources, such as freeing-up space from one logical volume or requesting a reallocation of storage space from one logical volume to another.

The configuration policy services 202, 204 may control the configuration elements 214a, b, c, 216a, b, c, 218a, b, c, and 220a, b, c over the Fibre Channel links or use an out-of-band communication channel, such as through a separate LAN connecting the devices 230, 232, and 234.

The configuration elements 214a, b, c, 216a, b, c, 218a, b, c, and 220a, b, c may be located on the same computing device including the requested resource, e.g., storage device 230, switch 232, host bus adaptors 234, or be located at a remote location from the resource being managed and configured.

In the described implementations, the service configuration policy service configures a switch when allocating storage space to a specified logical volume in a host. Additionally, if there are no switches (fabric) in the path between the specified host and storage device including the allocated space, there would be no configuration operation performed with respect to the switch.

In the described implementations, the service configuration policy was used to control elements related to the components within a SAN environment. Additionally, the configuration architecture of FIG. 2 may apply to any system in which an operation is performed, such as an allocation of resources, that requires the management and configuration of different resources throughout the system. In such cases, the elements may be associated with any element within the system that is manipulated through a configuration policy service.

In the described implementations, the architecture was used to alter the allocation of resources in the system. Additionally, the described implementations may be used to control system components through the elements to perform operations other than configuration operations, such as operations managing and controlling the device.

The above implementations were described with respect to a Fibre Channel environment. Additionally, the above described implementations of the invention may apply to other network environments, such as InfiniBand, Gigabit Ethernet, TCP/IP, iSCSI, the Internet, etc.

In the above described implementations, specific operations were described as being performed by a service configuration policy, device element configuration and device APIs. Alternatively, functions described as being performed with respect to one type of object may be implemented in another object. For instance, operations described as performed with respect to the element configurations may be performed by the service configuration policies.

The foregoing description of the implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for managing multiple resources in a system including at least one host, network, and a storage space comprised of at least one storage system that each host is capable of accessing over the network, comprising:
measuring and monitoring a plurality of service level parameters indicating a state of the resources in the system;
determining values for the service level parameters;
determining whether the service level parameter values satisfy predetermined service level thresholds;
indicating whether the service level parameter values satisfy the predetermined service thresholds; and
determining a modification of one at least one resource deployment or configuration if the value for the service level parameter for the resource does not satisfy the predetermined service level thresholds.

2. The method of claim 1, wherein the monitored service level parameter comprises one of a performance parameter and an availability level of at least one system resource.

3. The method of claim 2, wherein the service level performance parameters that are monitored are members of a set of performance parameters comprising: a downtime during which the at least one application is unable to access the storage space; a number of times the at least one application host was unable to access the storage space; a throughput in terms of bytes per second transferred between the at least one host and the storage; and an I/O transaction rate.

4. The method of claim 1, wherein the modification of resource deployment comprises at least one of adding additional instances of the resource and modifying a configuration of the resource.

5. The method of claim 1, wherein a time period is associated with one of the monitored service parameters, further comprising:
determining a time during which the value of the service level parameter associated with the time period does not satisfy the predetermined service level threshold; and
generating a message indicating that the determined time exceeds the time period if the determined time exceeds the time period associated with the monitored service parameter.

6. The method of claim 5, wherein a customer contracts with a service provider to provide the system at agreed upon service level parameters, further comprising:
transmitting a service message to the service provider after determining that the value of the service level parameter does not satisfy the predetermined service level; and
transmitting the message indicating failure of the value of the service level parameter for the time period to both the customer and the service provider.

7. The method of claim 1, further comprising writing to a log information indicating whether the service level parameter values satisfy the predetermined service thresholds.

8. The method of claim 1, wherein determining the modification of the at least one resource deployment further comprises:
analyzing the resource deployment to determine at least one resource that contributes to the failure of the service level parameter values to satisfy the threshold;
determining whether any additional instances of the determined at least one resource that contributes to the failure of the service level parameter is available; and
allocating at least one additional instance of the determined at least one resource to the system.

9. The method of claim 8, wherein analyzing the resource deployment comprises performing a bottleneck analysis.

10. The method of claim 8, further comprising:
determining characteristics of access to the resources by applications operating at the service level;
if there are no additional instances of the determined at least one resource, then determining whether the access characteristics exceed predetermined access characteristics; and
indicating that the service level is not sufficient due to a change in the access characteristics.

11. The method of claim 10, wherein the access characteristics include read/write ratio, Input/Output (I/O) size, and percentage of access being either sequential or random.

12. The method of claim 10, wherein the predetermined access characteristics are specified in a service level agreement that indicates the thresholds for the service level parameter values.

13. The method of claim 1, wherein a plurality of applications at different service levels are accessing the resources in the system, wherein requests from applications using a higher priority service receive higher priority than requests from applications operating at a lower priority service, wherein determining the modification of the at least one resource deployment further comprises:
increasing the priority associated with the service level whose service level parameter values fail to satisfy the predetermined service level thresholds.

14. The method of claim 13, wherein determining the modification of the at least one resource deployment further comprises:
analyzing the resource deployment to determine at least one resource that contributes to the failure of the service level parameter values to satisfy the thresholds;
determining whether any additional instances of the determined at least one resource that contributes to the failure of the service level parameter is available; and
allocating at least one additional instance of the determined at least one resource to the system, wherein the priority is increased if there are no additional instances of the at least one resource that contributes to the failure.

15. The method of claim 1, wherein one service level parameter value indicates a time throughput of Input/Output operations between the at least one host and the storage space has been below a throughput threshold, and wherein determining the additional resource allocation further comprises determining at least one of host adaptor, network, and storage resources to add to the configuration.

16. The method of claim 1, further comprising:
invoking an operation to implement the determined additional resource allocation.

17. The method of claim 1, wherein the service level parameters specify a predetermined redundancy of resources, further comprising:
detecting a failure of one component;
determining whether the component failure causes the resource deployment to fall below the predetermined redundancy fo resources; and
indicating whether the component failure causes the resource deployment to fall below the predetermined redundancy threshold.

18. A system for managing multiple resources in a system including at least one host, network, and a storage space comprised of at least one storage system that each host is capable of accessing over the network, comprising:
means for measuring and monitoring a plurality of service level parameters indicating a state of the resources in the system;
means for determining values for the service level parameters;
means for determining whether the service level parameter values satisfy predetermined service level thresholds;
means for indicating whether the service level parameter values satisfy the predetermined service thresholds; and
means for determining a modification of at least one resource deployment or configuration if the value for the service level parameter for the resource does not satisfy the predetermined service level thresholds.

19. The system of claim 18, wherein the service level performance parameters that are monitored are members of a set of performance parameters comprising: a downtime during which the at least one application is unable to access the storage space; a number of times the at least one application was unable to access the storage space; a throughput in terms of bytes per second transferred between the at least one application and the storage; and an I/O transaction rate.

20. The system of claim 18, wherein the modification of resource deployment comprises at least one of adding additional instances of the resource and modifying a configuration of the resource.

21. The system of claim 18, wherein a time period is associated with one of the monitored service parameters, further comprising:
means for determining a time during which the value of the service level parameter associated with the time period does not satisfy the predetermined service level threshold; and
means for generating a message indicating that the determined time exceeds the time period if the determined time exceeds the time period associated with the monitored service parameter.

22. The system of claim 18, wherein the means for determining the modification of the at least one resource deployment further performs:
analyzing the resource deployment to determine at least one resource that contributes to the failure of the service level parameter values to satisfy the threshold;
determining whether any additional instances of the determined at least one resource that contributes to the failure of the service level parameter is available; and
allocating at least one additional instance of the determined at least one resource to the system.

23. The system of claim 22, further comprising:
means for determining characteristics of access to the resources by applications operating at the service level;
means for determining whether the access characteristics exceed predetermined access characteristics if there are no additional instances of the determined at least one resource; and
means for indicating that the service level is not sufficient due to a change in the access characteristics.

24. The system of claim 18, wherein a plurality of applications at different service levels are accessing the resources in the system, wherein requests from applications using a higher priority service receive higher priority than requests from applications using a lower priority service, wherein determining the modification of the at least one resource deployment further comprises:
increasing the priority associated with the service level whose service level parameter values fail to satisfy the predetermined service level thresholds.

25. A system for managing multiple resources in a system including at least one host, network, and a storage space comprised of at least one storage system that each host is capable of accessing over the network, comprising:
a processing unit;
a computer readable medium accessible to the processing unit;
program code embedded in the computer readable medium executed by the processing unit to perform:
(i) measuring and monitoring a plurality of service level parameters indicating a state of the resources in the system;
(ii) determining values for the service level parameters;
(iii) determining whether the service level parameter values satisfy predetermined service level thresholds;
(iv) indicating whether the service level parameter values satisfy the predetermined service thresholds; and
(v) determining a modification of at least one resource deployment or configuration if the value for the service level parameter for the resource does not satisfy the predetermined service level thresholds.

26. The system of claim 25, wherein the service level performance parameters that are monitored are members of a set of performance parameters comprising: a downtime during which the at least one application is unable to access the storage space; a number of times the at least one application was unable to access the storage space; a throughput in terms of bytes per second transferred between the at least one application and the storage; and an I/O transaction rate.

27. The system of claim 25, wherein the program code for determining the modification of the resource deployment comprises at least one of adding additional instances of the resource and modifying a configuration of the resource.

28. The system of claim 25, wherein a time period is associated with one of the monitored service parameters, wherein the program code is further executed by the processing unit to perform:
determining a time during which the value of the service level parameter associated with the time period does not satisfy the predetermined service level threshold; and
generating a message indicating that the determined time exceeds the time period if the determined time exceeds the time period associated with the monitored service parameter.

29. The system of claim 25, wherein the program code for determining the modification of the at least one resource deployment further causes the processing unit to perform:
analyzing the resource deployment to determine at least one resource that contributes to the failure of the service level parameter values to satisfy the threshold;
determining whether any additional instances of the determined at least one resource that contributes to the failure of the service level parameter is available; and
allocating at least one additional instance of the determined at least one resource to the system.

30. The system of claim 29, wherein the program code is further executed by the processing unit to perform:
determining characteristics of access to the resources by applications operating at the service level;
determining whether the access characteristics exceed predetermined access characteristics if there are no additional instances of the determined at least one resource; and
indicating that the service level is not sufficient due to a change in the access characteristics.

31. The system of claim 25, wherein a plurality of applications at different service levels are accessing the resources in the system, wherein requests from applications using a higher priority service receive higher priority than requests from applications using a lower priority service, wherein the program code for determining the modification of the at least one resource deployment further causes the processing unit to perform:
increasing the priority associated with the service level whose service level parameter values fail to satisfy the predetermined service level thresholds.

32. An article of manufacture including code for managing multiple resources in a system including at least one host, network, and a storage space comprised of at least one storage system that each host is capable of accessing over the network, wherein the code is capable of causing operations comprising:
measuring and monitoring a plurality of service level parameters indicating a state of the resources in the system;
determining values for the service level parameters;
determining whether the service level parameter values satisfy predetermined service level thresholds;
indicating whether the service level parameter values satisfy the predetermined service thresholds; and
determining a modification of one at least one resource deployment or configuration if the value for the service level parameter for the resource does not satisfy the predetermined service level thresholds.

33. The article of manufacture of claim 32, wherein the monitored service level parameter comprises one of a performance parameter and an availability level of at least one system resource.

34. The article of manufacture of claim 33, wherein the service level performance parameters that are monitored are members of a set of performance parameters comprising: a downtime during which the at least one host is unable to access the storage space; a number of times the at least one host was unable to access the storage space; a throughput in terms of bytes per second transferred between the at least one host and the storage; and an I/O transaction rate.

35. The article of manufacture of claim 32, wherein the modification of resource deployment comprises at least one of adding additional instances of the resource and modifying a configuration of the resource.

36. The article of manufacture of claim 32, wherein a time period is associated with one of the monitored service parameters, further comprising:
determining a time during which the value of the service level parameter associated with the time period does not satisfy the predetermined service level threshold; and
generating a message indicating that the determined time exceeds the time period if the determined time exceeds the time period associated with the monitored service parameter.

37. The article of manufacture of claim 36, wherein a customer contracts with a service provider to provide the system at agreed upon service level parameters, further comprising:
transmitting a service message to the service provider after determining that the value of the service level parameter does not satisfy the predetermined service level; and
transmitting the message indicating failure of the value of the service level parameter for the time period to both the customer and the service provider.

38. The article of manufacture of claim 32, further comprising writing to a log information indicating whether the service level parameter values satisfy the predetermined service thresholds.

39. The article of manufacture of claim 32, wherein determining the modification of the at least one resource deployment further comprises:
analyzing the resource deployment to determine at least one resource that contributes to the failure of the service level parameter values to satisfy the threshold;
determining whether any additional instances of the determined at least one resource that contributes to the failure of the service level parameter is available; and
allocating at least one additional instance of the determined at least one resource to the system.

40. The article of manufacture of claim 39, wherein analyzing the resource deployment comprises performing a bottleneck analysis.

41. The article of manufacture of claim 39, further comprising:
determining characteristics of access to the resources by applications operating at the service level;
if there are no additional instances of the determined at least one resource, then determining whether the access characteristics exceed predetermined access characteristics; and
indicating that the service level is not sufficient due to a change in the access characteristics.

42. The article of manufacture of claim 41, wherein the access characteristics include read/write ratio, Input/Output (I/O) size, and a percentage of access being either sequential or random.

43. The article of manufacture of claim 41, wherein the predetermined access characteristics are specified in a service level agreement that indicates the thresholds for the service level parameter values.

44. The article of manufacture of claim 32, wherein a plurality of applications at different service levels are accessing the resources in the system, wherein requests from applications using a higher priority service receive higher priority than requests from applications operating at a lower priority service, wherein determining the modification of the at least one resource deployment further comprises:
increasing the priority associated with the service level whose service level parameter values fail to satisfy the predetermined service level thresholds.

45. The article of manufacture of claim 44, wherein determining the modification of the at least one resource deployment further comprises:
analyzing the resource deployment to determine at least one resource that contributes to the failure of the service level parameter values to satisfy the thresholds;
determining whether any additional instances of the determined at least one resource that contributes to the failure of the service level parameter is available; and
allocating at least one additional instance of the determined at least one resource to the system, wherein the priority is increased if there are no additional instances of the at least one resource that contributes to the failure.

46. The article of manufacture of claim 32, wherein one service level parameter value indicates a time throughput of Input/Output operations between the at least one host and the storage space has been below a throughput threshold, and wherein determining the additional resource allocation further comprises determining at least one of host adaptor, network, and storage resources to add to the configuration.

47. The article of manufacture of claim 32, further comprising:
invoking an operation to implement the determined additional resource allocation.

48. The article of manufacture of claim 32, wherein the service level parameters specify a predetermined redundancy of resources, further comprising:
detecting a failure of one component;
determining whether the component failure causes the resource deployment to fall below the predetermined redundancy fo resources; and
indicating whether the component failure causes the resource deployment to fall below the predetermined redundancy threshold.
